(19) United States
(12) Patent Application Publication
(10) Pub. No.: US 2024/0284396 A1
(43) Pub. Date: Aug. 22, 2024

(54) NETWORK VERIFIED USER DEVICE POSITION IN A WIRELESS COMMUNICATION NETWORK

(71) Applicant: Fraunhofer-Gesellschaft zur Foerderung der angewandten Forschung e.V., Munich (DE)

(72) Inventors: Birendra GHIMIRE, Erlangen (DE); Norbert FRANKE, Erlangen (DE); Thomas HEYN, Erlangen (DE)

(21) Appl. No.: 18/398,810

(22) Filed: Dec. 28, 2023

Related U.S. Application Data
(63) Continuation of application No. PCT/EP2022/068100, filed on Jun. 30, 2022.

(30) Foreign Application Priority Data
Jun. 30, 2021 (EP) 21182993.2

(51) Int. Cl. H04W 64/00; G01S 5/00; G01S 5/02; H04W 84/06

(52) U.S. Cl. CPC H04W 64/006; G01S 5/0036; G01S 5/0236; G01S 5/0244; G01S 5/0263; H04W 84/06

(57) ABSTRACT

A network, NW, entity for a wireless communication network is described. The wireless communication network includes one or more non-terrestrial network, NTN, components, like an airborne vehicle or a spaceborne vehicle. The NW entity obtains information for determining a network, NW, generated UE position of a user device, UE, and determines the NW generated UE position solving a linear system or equations and/or using one or more artificial intelligence, AI/machine learning (ML), models using as an input one or some or all of the obtained information and/or verifies the NW generated UE position using one or some or all of the obtained information.

### CROSS-REFERENCE TO RELATED APPLICATIONS

This application is a continuation of copending International Application No. PCT/EP2022/068100, filed Jun. 30, 2022, which is incorporated herein by reference in its entirety, and additionally claims priority from European Application No. EP 21182993.2, filed Jun. 30, 2021, which is also incorporated herein by reference in its entirety.

The present invention refers to wireless communication systems or networks, more specifically to wireless communication networks including non-terrestrial network, NTN, components. Embodiments concern the verification of a position of a user device, UE, within such a wireless communication network.

### BACKGROUND OF THE INVENTION

FIG. 1 is a schematic representation of an example of a wireless network 100 including, as is shown in FIG. 1(a), the core network 102 and one or more radio access networks RAN₁, RAN₂, . . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure.

FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UEs as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the Xn interface in NR, with each other via respective backhaul links 1161 to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations.

The above described wireless network may also include non-terrestrial network, NTN, components. The wireless communication network including terrestrial components and non-terrestrial components refers to networks or segments of networks using an airborne or spaceborne vehicle for transmission, i.e., a transceiver of the network communicating with the users and the core network is provided in an airborne or spaceborne vehicle. Spaceborne vehicles may include satellites with different altitudes or orbital periods, like a low earth orbit, LEO, a medium earth orbit, MEO, a geosynchronous orbit, GSO, a geostationary orbit, GEO, or a high earth orbit, HEO, whereas airborne vehicles may include unmanned aircraft systems, UAS, such as a tethered UAS, a lighter than air, LTA, UAS, a heavier than air, HTA, UAS, and a high altitude UAS platform, HAP.

FIG. 2 is a schematic representation of an example of a wireless communication network 150 including a core network 152, a radio access network 154 having respective base stations/NTN gateways 154₁ and 154₂, and a plurality of spaceborne transceivers 156, like satellites, and/or airborne transceivers 158, like unmanned aircraft systems. The respective spaceborne or airborne transceivers 156, 158 may be implemented in respective spaceborne or airborne vehicles, like the above mentioned satellites or unmanned aircraft systems. The transceivers 156 and 158 are provided to serve one or more users, like the UE or the IoT device 110 shown in FIG. 2, which are provided on or above ground 160. The UE and the IoT device may be devices as described above with reference to FIG. 1. The arrows 158₁ to 158₄ schematically represent uplink/downlink connections for communicating data between the user UE, 110 and the respective transceiver 156, 158, also referred to as service links. The transceivers 156, 158 are connected to the core network 152 via the RAN entities 154₁, 154₂, via respective links 162₁, 162₂, also referred to as feeder links.

A NTN component may operate in accordance with the so called bent pipe or u-bend principle, sending back to earth what goes into the conduit with only amplification and a shift from uplink to downlink frequencies at the NTN component. Payload transmitted using this principle is also referred to as bent pipe payload or transparent payload. In accordance with other examples, a NTN component may use on-board processing so that the signal is demodulated, decoded, re-encoded and modulated aboard the NTN component. Payload transmitted using this principle is also referred to as regenerative payload.

It is noted that the information in the above section is only for enhancing the understanding of the background of the invention and therefore it may contain information that does not form the conventional technology that is already known to a person of ordinary skill in the art.

In a wireless communication network having one or more NTN components as described above, there may be a need for improvements in the determination/verification of a position of a UE connected via the one or more NTN components to the RAN.

### SUMMARY

One embodiment may have a network, NW, entity for a wireless communication network, the wireless communication network including one or more non-terrestrial network, NTN, components, like an airborne vehicle or a spaceborne vehicle, wherein the NW entity is to obtain information for determining a network, NW, generated UE position of a user device, UE, and determine, using as an input one or some or all of the obtained information, the NW generated UE position by solving a linear system or equations and/or using one or more artificial intelligence, AI, or machine learning, ML, models, and/or verify the NW generated UE position using one or some or all of the obtained information.

Another embodiment may have a user device, UE, for a wireless communication network, the wireless communication network including one or more non-terrestrial network, NTN, components, like an airborne vehicle or a spaceborne vehicle, wherein the UE is to provide one or more of the following information: information for determining and/or verifying a network, NW, generated UE position of the UE at a network, NW, entity of the wireless communication network, and/or a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

According to another embodiment, a wireless communication system may have: one or more non-terrestrial network, NTN, components, and one or more inventive network, NW, entities and/or one or more inventive user devices, UEs.

According to another embodiment, a method for operating a network, NW, entity for a wireless communication network, the wireless communication network including one or more non-terrestrial network, NTN, components, like an airborne vehicle or a spaceborne vehicle, may have the steps of: obtaining information for determining a network, NW, generated UE position of a user device, UE, and determining using as an input one or some or all of the obtained information the NW generated UE position by solving a linear system or equations and/or using one or more artificial intelligence, AI, or machine learning, ML, models, and/or verifying the NW generated UE position using one or some or all of the obtained information.

According to another embodiment, a method for operating a user device, UE, for a wireless communication network, the wireless communication network including one or more non-terrestrial network, NTN, components, like an airborne vehicle or a spaceborne vehicle, may have the steps of: providing, by the UE, one or more of the following information: information for determining and/or verifying a network, NW, generated UE position of the UE at a network, NW, entity of the wireless communication network, and/or a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1a-b shows a schematic representation of an example of a terrestrial wireless communication network;

FIG. 2 is a schematic representation of an example of a non-terrestrial wireless communication network;

FIG. 3 illustrates a signaling between a UE, a NG-RAN node and an AMF for registering a UE into a core network;

FIG. 4 illustrates an example for the content of the RRCSetupCompleteIE;

FIG. 5 is a schematic representation of a wireless communication system for implementing embodiments of the present invention;

FIG. 6 illustrates an embodiment of the present invention determining/verifying the UE position using a combination of a GNSS and one or more NTN satellites;

FIG. 7 illustrates an embodiment of a UE position verification using the measurements of a plurality of satellites of a NTN;

FIG. 8 illustrates an embodiment of a UE position verification using the measurements of a single satellite LEO of a NTN;

FIG. 9 illustrates a NTN in accordance with embodiments determining/verifying a UE position using measurements in the NTN;

FIG. 10 illustrates an embodiment determining/verifying a position of a NTN-capable UE by combining at least one measurement to a terrestrial TRP and at least one measurement from the NTN;

FIG. 11 illustrates an embodiment determining/verifying a position of a NTN-capable UE using a sidelink;

FIG. 12 illustrates an embodiment allowing a NTN-capable UE to identify its position with reference to a certain reference point signaled by the NTN;

FIG. 13 illustrates virtual cells in a NTN having different radii;

FIG. 14 illustrates the mapping of grid points on a plane to virtual cells and indicates whether a virtual cell belong to a certain PLMN, provided that the diagonally opposite corners of the plane are provided and the separation between adjacent grid points is provided;

FIG. 15 illustrates an embodiment using time variant measurements from one or two satellites for a verification of a UE position; and

FIG. 16 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

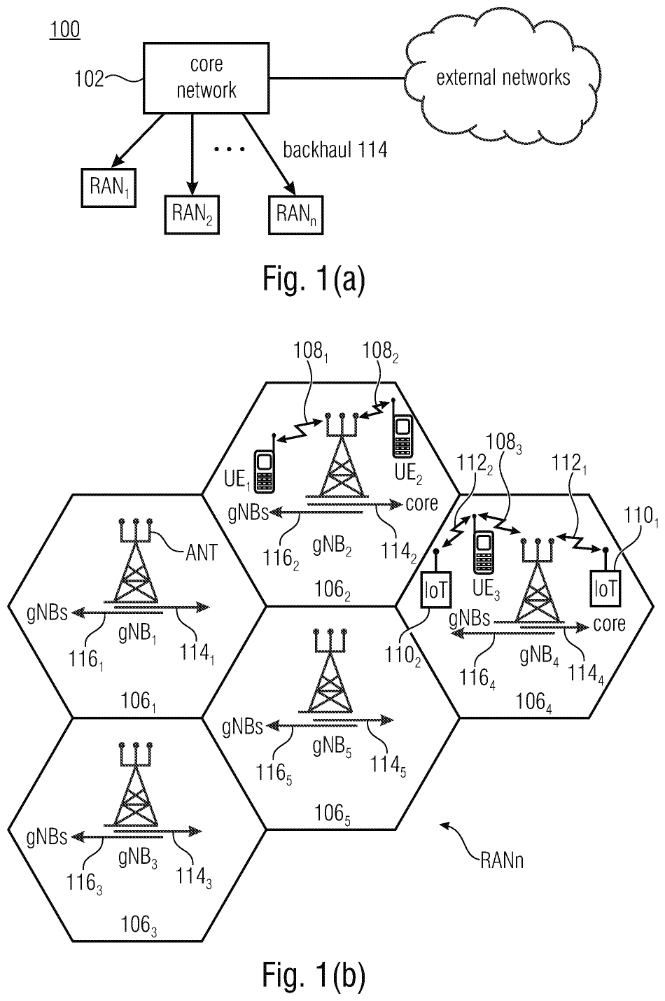

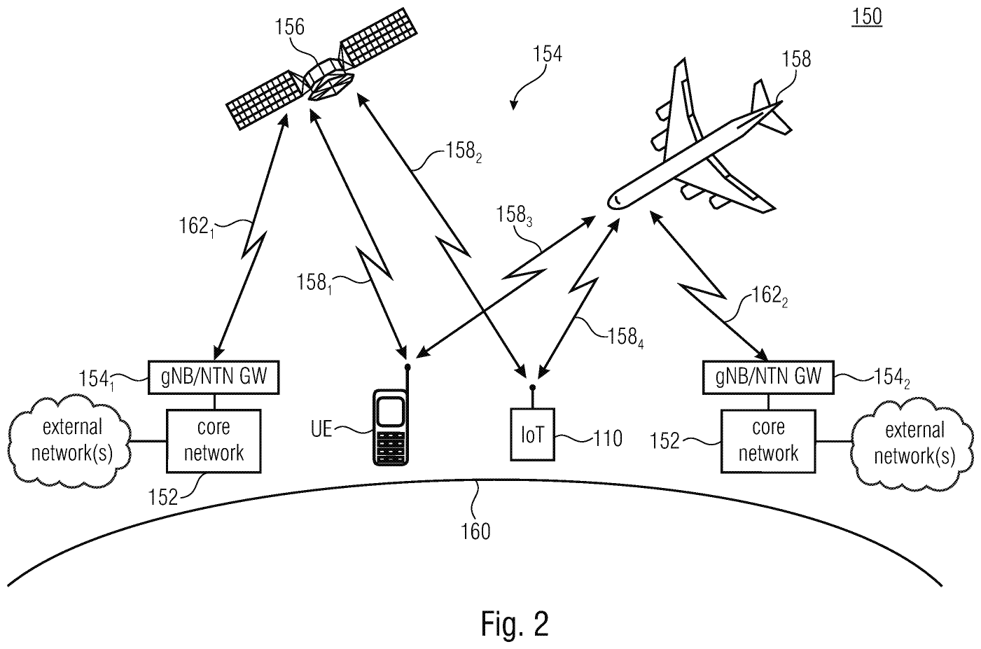

In a wireless communication network as described above with reference to FIG. 1, in accordance with the 5G regulations, certain requirements for the localization are defined. For example in 3GPP TS 22.261, it is specified that the 5G system is to supply a method for the operator to configure and manage different positioning services for different users, is to be able to determine the reliability and the uncertainty or confidence level of position-related data, and is to be able to access positioning methods used for calculating position-related data and associated uncertainty/confidence indicators. However, for a non-terrestrial network, NTN, like the one described above with reference to FIG. 2, it may be a challenge to verify a UE position or location due to the significantly different network deployment using NTN components, like satellites, instead of terrestrial base stations.

A UE position location is needed, for example, at different entities in the mobile network at various levels of detail and for various purposes. For example, before a UE or user device attaches to a network, the access and mobility management function, AMF, needs to know the cell the UE is to be attached to. In accordance with other examples. in case the UE or a network entity of the wireless communication network initiates an emergency call, the call needs to be forwarded to an appropriate Public Safety Answering Point, PSAP. Furthermore, a NTN network operator may operate in areas for which he acquired a license, so that for making sure that a UE is actually located in one of the licensed areas, the network needs to locate the UE within a certain area, e.g., within a country border. Then, the network may be operated within the framework of national regulations allowed by the license.

In accordance with the 3GPP Subcommittee on Security, SA3-LI, the main requirements regarding reliable positioning within NTN networks may be summarized as follows:
A logical location information, like the cell ID, needs to be reliable, i.e., needs to be determined by the network or needs to be verified by the network.
The logical location needs to unambiguously map to a geographical area of the UE's physical location. The granularity of such geographical area is to be able to provide a network location accuracy that is comparable to the one achievable in terrestrial networks.
Any solution needs to support the ability to enforce the use of a core network, CN, of a public land mobile network, PLMN, in the country where the UE is physically located. The enforcement needs also to include cross-border continuity scenarios.
A solution addressing extraterritorial use cases, like an international maritime use case or an aeronautical use case, needs to provide means to notify the home PLMN, HPLMN, on roaming in and out of those areas, including cases when the serving PLMN does not change.

A user device operating, for example, in a wireless communication network as described above with reference to FIG. 2, may include functionality for determining its position or location, like its location or position within a certain area or on the surface of the earth, using a positioning system separate or external to the LTE or NR system. In other words, the user device may employ a positioning system separate from a wireless communication network as described with reference to FIG. 1 or FIG. 2 system for determining its location or position within a certain area covered by the system, like the surface of the earth for a satellite-based system. Such systems may be used by any device that desired to determine its position. Such positioning systems are also referred to as RAT-independent systems and may include a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

In the following, the A-GNSS is discussed in more detail as an example for the positioning system used by a UE for determining its position on its own. However, the following discussing equally applies to any other non-terrestrial or terrestrial positioning system. While a positioning system may provide the location information, the A-GNSS or any other positioning system may not be sufficient for providing the UE position or location with a reliability needed by the NTN, for example, for determining to which PLMN a user device is to be attached. In other words, the position information obtained using the A-GNSS may not be sufficient for the NTN to finally decide about the actual geographical location where the UE is located. Also in other use cases, the information may not be sufficient. For example, when considering an emergency call use case, the legal requirements, like the requirements of the US Federal Communications Commission, FCC, may requirement a 50 meter accuracy for 80% of all calls with the additional requirement of locating a UE within +3 meters in the horizontal direction. The EU regulations call for a horizontal positioning error of a maximum of 5 meters in open sky conditions and a maximum of 25 meters in a urban canyon condition with a confidence level of 95%. The UE position or location obtained by the mentioned positioning systems may not be sufficient to meet such requirements.

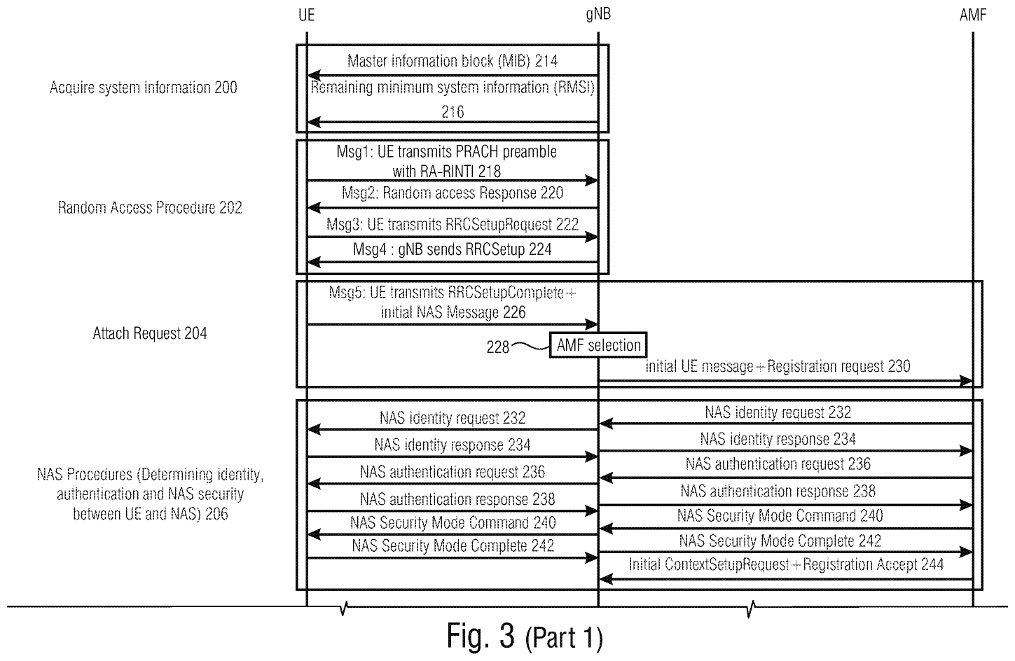

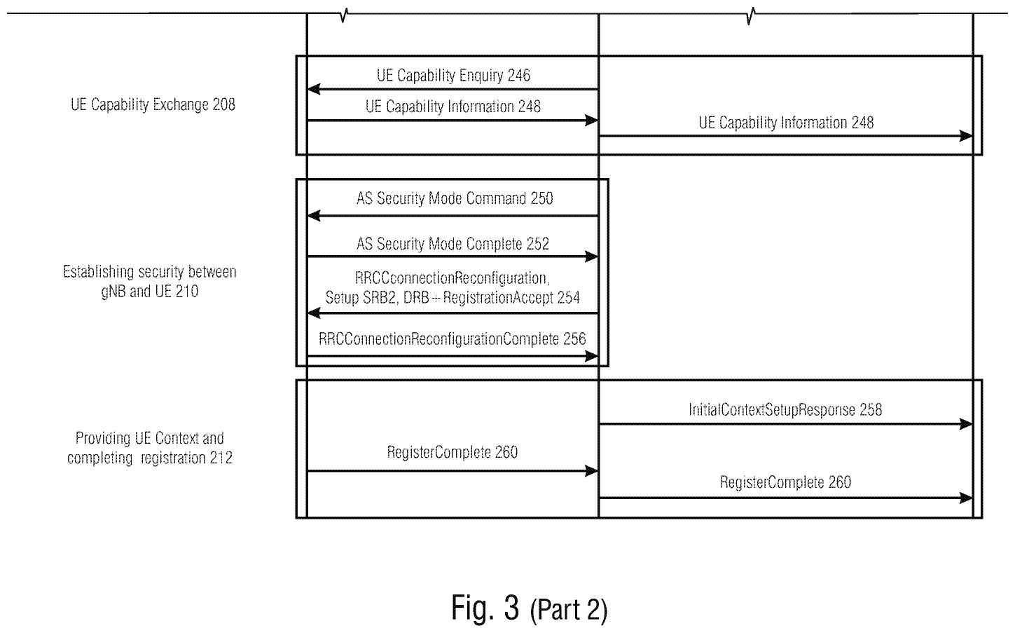

In case of a terrestrial network, the UE location, for example provided to the AMF at the time of registration, pertains to the information of the serving cell. This information may include the new radio cell global ID, NR-CGI, the timing advance index, TAI, an age of the UE location at which the location information was generated, expressed, e.g., as coordinated universal time, UTC, and a network identifier, NID. In such a terrestrial network, the mapping of the UE location to a certain area or to a country based on the serving NG-RAN node is trivial because the location of the serving NG-RAN node is known. The signaling between a UE and an AMF for registering the UE into a core network is described, for example, in 3GPP TS 38.401. FIG. 3 illustrates the signaling between a UE, a NG-RAN node and an AMF for registering the UE into the core network. The NG-RAN node may be a gNB formed by a central unit, CU, and a distributed unit DU, however, for simplicity, this split is not illustrated. Also, the signaling within the core network is not illustrated.

The procedure for registering a UE in a core network, as illustrated in FIG. 3, includes the following blocks:
the acquiring system information 200,
the random access procedure 202,
the attach request 204, the non-access stratum, NAS, procedures 206 for establishing NAS identity and NAS security,
the UE capability exchange 208,
the establishment of the access stratum, AS, security 210, and
the completion of the registration 212.

For acquiring the system information 200, the UE receives from the gNB the master information block, MIB, 214 as well as the remaining minimum system information, RMSI, 216.

During the random access procedure 202, the UE may send Msg1 218 for transmitting the PRACH preamble, and receives from the gNB Msg2 220 including the random access response. The UE sends Msg3 222 for transmitting the RRCSetupRequest, and receives from the gNB Msg4 224 including the RRCSetup. The random access procedure 202, instead of the described four step RACH procedure, may also a two-step RACH procedure.

The attach request 204 includes sending Msg5 226 including the RRCSetupComplete and the initial NAS messages from the UE to the gNB. The gNB selects 228 the AMF to which the UE is to be registered and sends to the selected AMF an initial UE message and registration request 230.

During the NAS procedures 206, the selected AMF sends the NAS identity request 232 via the gNB to the UE. The UE sends the NAS identity response 234 via the gNB to the AMF. An NAS authentication request 236 is transmitted via the gNB to the UE, and the NAS authentication response 238 is transmitted from the UE via the gNB to the AMF. The AMF then sends the NAS security mode command 240 that is transmitted via the gNB to the UE which responds to the command with the NAS security mode complete message 242 that is forwarded via the gNB to the AMF. Once the security procedures are completed, the AMF returns to the gNB the initial ContextSetupRequest and registration accept message 244.

Following the NAS procedures 206, the UE capabilities are exchanged 208. The gNB sends the UE capability inquiry 246 to the UE which returns the UE capability information 248 to the gNB which also forwards this information to the AMF.

After exchanging the UE capabilities 208, the security between the gNB and the UE is established 210, and the gNB sends the AS security mode command 250 to the UE. The UE responds with the AS security mode complete message 252, responsive to which the gNB sends the RRCCconnection ReconfigurationSetup, SRB2, DRB and registration accept message 254 to which the UE answers with the RRCConnectionReconfigurationComplete message 256.

For providing the UE context and completing the registration 212, the gNB sends the InitialContextSetupResponse 258 to the AMF, and the RegisterComplete message 260 is provided by the UE to the AMF via the gNB.

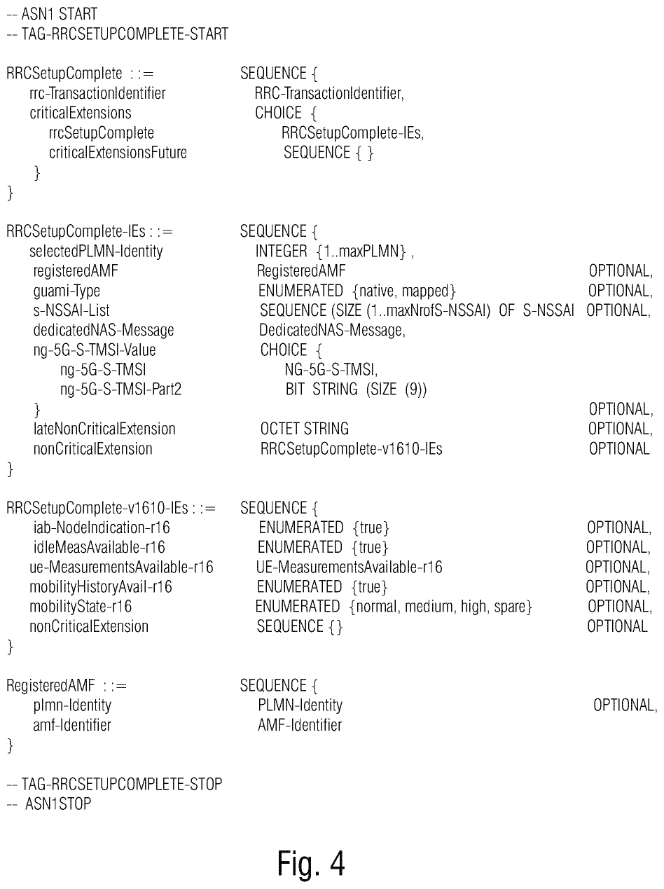

The above mentioned RRCSetupComplete message signaled by the UE to the gNB during the attach request 204 may be an information element, IE, as defined by 3GPP TS 38.331. FIG. 4 illustrates an example for the content of the RRCSetupCompleteIE. For example, in Rel.-16, the mandatory fields included in the RRCSetupCompleteIE are the selectedPLMN-Identity and the dedicatedNAS-Message. The selectedPLMN-Identity corresponds to the PLMN identifier broadcast by the cell in the SIB message. The content of the dedicatedNAS-Message is not transparent to the gNB. The IE registeredAMF provides the globally unique AMF identifier, GUAMI, of the AMF where the UE is registered. For terrestrial networks, the UE may select the PLMN broadcast by the cell in the SIB1 and initiate the random access procedure 202.

However, the situation is different in a NTN, in which, for example, the satellite cells go across several areas, like country borders. A NTN-capable UE, for example according to 3GPP Rel.-17, is equipped with A-GNSS functionality and may compute its position or location independently, optionally using assistance data provided by the NTN. However, the NTN is not able to verify independently whether the location of the UE reflects its correct location or not. Moreover, the GNSS position may be spoofed or jammed. Thus, it is difficult to determine whether a UE position as reported by the UE is at a sufficient reliability, for example, for the NTN operator. In other words, the NTN cell may span country borders and the NG-RAN may not have enough information at this stage for selecting the correct PLMN.

Thus, when considering the attach request procedure 204 described above with reference to FIG. 3, initially, the UE may send the RRCSetupComplete message 226 for initiating the registration with the AMF of the NTN. Besides other parameters, the location information in the UE message is of particular interest and may include, for example in case of NR, the NR-CGI and the tracking area identifier as well as the age of the location as mentioned above. A NTN-capable UE may determine its location using external systems, such as a GNSS. The UE may use the UE-determined location to determine a suitable PLMN to attach to from a set of PLMNs it is allowed to select from, for example according to criteria set by higher layers and information in the UMTS subscriber identification module, USIM. In such a case the UE-determined location is the basis to generate the dedicatedNAS-message from the UE to the AMF to register the UE with the NTN and to indicate to the NG-RAN node which PLMN the UE is to initiate a connection to. In accordance with 3GPP TS 23.501, for a NR satellite access, a UE with location capability is to use its awareness of its location to select a PLMN that is allowed to operate in the country of the UE location as is specified in 3GPP TS 23.122. In order to ensure that the regulatory requirements are met, the NTN is to enforce the UE choice either by rejecting any NAS request targeted towards a PLMN that is not allowed to operate at the known UE location or by accepting the NAS procedure and later deregister the UE once the UE location is known, as is specified in 3GPP TS 23.502. To fulfill the requirements of 3GPP TS 23.501 and to satisfy the requirements issued by the subcommittee for security, SA3-LI, the network node needs to conclude or determine the UE position based on measurements at the network side or it needs to verify the user location reported by the UE at the network side.

However, before the AMF is actually selected (see 228 in FIG. 3), there is no signaling connection between the UE and a location management function, LMF. Therefore, a UE may only use the A-GNSS in standalone mode or in UE-based mode, however, the current signaling mechanism does not allow the UE to report its position to the network before AS security 210 (see FIG. 3) is established. Moreover, the NG-RAN node does not have any mechanism to verify or generate a UE position before the registration is completed.

In accordance with Rel.-16., the location of a UE may be determined at the LMF using positioning methods as indicated in the following table:

| | | | NG- | |
|---|---|---|---|---|
| | | UE- | RAN | |
| | UE- | assisted, | node | |
| Method | based | LMF-based | assisted | Remarks |
| A-GNSS | Yes | Yes | No | RAT-independent |
| OTDOA | No | Yes | No | Legacy E-UTRA |
| | | | | positioning method |
| E-CID | No | Yes | Yes | Legacy E-UTRA |
| | | | | positioning method |
| Sensor | Yes | Yes | No | RAT-independent |
| WLAN | Yes | Yes | No | RAT-independent |
| Bluetooth | No | Yes | No | RAT-independent |
| TBS | Yes | Yes | No | RAT-independent |
| DL-TDOA | Yes | Yes | No | Specified in Rel. 16 5G-NR |
| DL-AoD | Yes | Yes | No | Specified in Rel. 16 5G-NR |
| Multi-RTT | No | Yes | Yes | Specified in Rel. 16 5G-NR |
| NR E-CID | No | Yes | Yes | Specified in Rel. 16 5G-NR |
| UL-TDOA | No | No | Yes | Specified in Rel. 16 5G-NR |
| UL-AoA | No | No | Yes | Specified in Rel. 16 5G-NR |

The positioning methods in table may be categorized into the three categories indicated in the column “Remarks”:
1) positioning methods from previous releases based on LTE signals, referred to as “legacy E-UTRA positioning method”, like OTDOA, E-CID,
2) positioning methods, referred to as RAT-independent, which are based on the above mentioned external systems,
3) positioning methods referred to as “specified in Rel.-16 5G-NR”, which are based on NR signals for Rel.-16, like DL-TDOA, DL-AOD, multi-RTT, NRE-CID, UL-TDOA, UL-AOA.

From the above table, the methods A-GNSS, DL-TDOA, DL-AOD, multi-RTT, UL-TDOA, NR-ECID and UL-AOA allow generating the position at the network side. The positioning methods in Rel.-16 are specified for terrestrial networks and additional adjustments are needed for using them in a NTN network. For example, A-GNSS is the only method which may be used for NTN networks. For A-GNSS assistance data (see 3GPP TS 38.305) may be provided over the NTN satellite, for example in the form of the Positioning System Information Blocks, posSIBs. The following assistance data may be defined for GNSS systems according to 3GPP TS 38.305:

Assistance Data

Reference Time
Reference Location
Ionospheric Models
Earth Orientation Parameters
GNSS-GNSS Time Offsets
Differential GNSS Corrections
Ephemeris and Clock Models
Real-Time Integrity
Data Bit Assistance
Acquisition Assistance
Almanac
UTC Models
RTK Reference Station
Information
RTK Auxiliary Station Data
RTK Observations
RTK Common Observation
Information
GLONASS RTK Bias Information
RTK MAC Correction Differences
RTK Residuals
RTK FKP Gradients
SSR Orbit Corrections
SSR Clock Corrections
SSR Code Bias
SSR Phase Bias
SSR STEC Corrections
SSR Gridded Correction
SSR URA
SSR Correction Points

However, for generating the UE position at the network side, the UE needs to provide measurement reports to the LMF. For example, according to 3GPP TS 38.305, the UE may provide the following information to the LMF in a UE-assisted mode and in a UE-based/standalone mode:

| | UE- | UE-based/ |
|---|---|---|
| Information | assisted | stand alone |
| Latitude/Longitude/Altitude, together with | No | Yes |
| uncertainty shape | | |
| Velocity, together with uncertainty shape | No | Yes |
| Reference Time, possibly together with GNSS to | Yes | Yes |
| NG-RAN time association and uncertainty | | |
| Indication of used positioning methods in the fix | No | Yes |
| Code phase measurements, also called | Yes | No |
| pseudorange | | |
| Doppler measurements | Yes | No |
| Carrier phase measurements, also called | Yes | No |
| Accumulated Delta Range (ADR) | | |
| Carrier-to-noise ratio of the received signal | Yes | No |
| Measurement quality parameters for each | Yes | No |
| measurement | | |
| Additional, non-GNSS related measurement | Yes | No |
| information | | |

Thus, terrestrial networks may carry out a UE position determination using either wireless communication network signals, for example LTE signals up to Rel.-15, like the Observed Time Difference Of Arrival, OTDOA, or the Enhanced Cell ID, E-CID, or NR signals for Rel.-16, like the Downlink Time Difference Of Arrival, DL-TDOA, the Downlink Angle of Departure DL-AoD, the Uplink Time Difference Of Arrival, UL-TDOA, the Uplink Angle of Arrival, UL-AoA, the Multi-Round Trip Time, Multi-RTT, or the New Radio Enhanced Cell ID, NR R-CID. Alternatively or in addition, positioning approaches using external systems, like an Assisted-Global Navigation Satellite System, A-GNSS, or a Terrestrial Beacon System, TBS, or systems supported by other networks, like a Wireless Local Access Network, WLAN, or Bluetooth, may be applied as well. However, the UE-assisted mode does not satisfy the requirements for obtaining the NW generated UE position or for verifying the UE reported UE position at the network side of the NTN because the measurements, such as the code-phase measurements, the Doppler measurements, the carrier phase measurements, are generated by the UE and are subject to the UE implementation. Further, A-GNSS in a UE-assisted/LFM-based mode is executed in the LMF that is located in the core network and only possible once the UE has signaling access to the LMF which is not the case until the AMF is selected.

Thus, conventional non-terrestrial networks face the problem that, initially, only a position of a UE is available that is actually determined by the UE itself, for example by using the above-mentioned external systems, like the A-GNSS. However, this information may not be sufficient or may not be considered sufficiently reliable by the NTN for allowing a new UE to attach to the NTN. Also, a UE reported UE position of a UE already attached to the NTN may not be sufficient or may not be considered sufficiently reliable by the NTN for use in specific regulatory situations, like emergency call use cases. In other words, NTN capable UEs may have a GNSS receiver, however, the UE location computed and reported by the UE itself may not be considered sufficiently reliable or trustworthy by the network from a 3GPP SA 3-LI perspective.

Thus, when considering the above-described conventional approaches, there is a need for improvements in the determination/verification of a position of a UE in a NTN.

Embodiments of the present invention address the above issues and provide different approaches that allow to determine the UE position or location within a NTN at the network side to obtain a network, NW, generated UE position or to verify at the network side location information provided by the UE, also referred to as the UE reported UE position.

### NW Entity Determining UE Positon in NTN Using Certain Information

The present invention provides a network, NW, entity for a wireless communication network, the wireless communication network including one or more non-terrestrial network, NTN, components, like an airborne vehicle or a spaceborne vehicle, wherein the NW entity is to
obtain information for determining a network, NW, generated UE position of a user device, UE, and
determine and/or verify the NW generated UE position using the obtained information.

In accordance with embodiments, the information for determining the NW generated UE position of the UE comprises one or more of the following:
one or more measurements from the UE,
one or more measurements from one or more further NW entities of the wireless communication network, the one or more further NW entities performing the one or more measurements,
one or more measurements made by the NW entity,
coordinates of a reference point in the wireless communication network that is less than a predefined distance from the UE,
a reference device in the wireless communication network that is within a hearability range of the UE.

In accordance with embodiments, the one or more measurements comprise one or more of the following:
one or more measurements of one or more ranges between the UE and at least one satellite of a Global Navigation Satellite System, GNSS, used by the UE to determine the UE position,
one or more measurements of a range, like time of flight, ToF, or a range difference, like time difference of arrival, TDOA, between the one or more NTN components,
one or more measurements of a range, like ToF, or a range difference, like TDOA, between one or more reference devices, like a terrestrial transmission and reception point, TRP,
a combination one or more measurements of a range, like ToF, and/or a range difference, like TDOA, using one or more signals transmitted and/or received by at least a first system and at least a second system, one or more measurements of a range, like time of flight, ToF, between the UE and a first entity in the RAN and one or more measurements of a range difference, like TDOA, between the UE and at least a second entity in the RAN,
in case the wireless communication network includes as NTN components one or more satellites, like satellites of a GNSS, one or more time variant measurements from a single satellite or from multiple satellites, e.g., one or more of the following: a change in the measured range from the UE to the satellite, a change in a measured Doppler shift, a change in a measured angle from the satellite to the UE.

In accordance with embodiments, the first system and the second system comprises:
a GNSS,
one or more TRPs of one or more terrestrial networks,
one or more integrated access and backhaul nodes, IABs,
one or more access network entities of one or more non-terrestrial networks, like
one or more NTN satellites,
one or more terrestrial beacon systems,
one or more reference devices in the wireless communication network, and the first entity in the RAN and the second entity in the RAN comprises:
one or more TRPs of one or more terrestrial networks,
one or more integrated access and backhaul nodes, IABs,
one or more access network entities of one or more non-terrestrial networks, like one or more NTN satellites,
one or more terrestrial beacon systems,
one or more reference devices in the wireless communication network.

In accordance with embodiments, the NW entity is to
receive from the UE a UE position, the UE position indicating a geographical location of the UE, and
verify the received UE position using the NW generated UE position.

In accordance with embodiments,
during a registration with the wireless communication network, the NW entity is to receive from the UE an altered version of the UE position, e.g., a UE position having added thereto an offset and/or a rotation, and
in case the NW entity verified the altered version of the UE position and the UE is allowed to access the wireless communication network, the NW entity is to retrieve a true UE position from the altered version of the UE position by undoing the alteration done by the UE, e.g., responsive to one or more reverse transformation parameters provided by the core network after AS security is enabled.

In accordance with embodiments, the UE position is determined using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

In accordance with embodiments,
the NW entity is to transmit positions and reference point identifiers of one or more reference points in the wireless communication network, and
the UE position is the position of the reference point that is less than a predefined distance from the UE, e.g., the reference point among a plurality of reference points to which the UE is closest.

In accordance with embodiments, the NW entity is to receive from the UE a location report including
the UE position, like a geographical location, e.g., a latitude, a longitude, an altitude, or
information derived from the UE location and from assistance data obtained from the wireless communication network, e.g., a location of one or more virtual points and an association of the one or more virtual points with one or more of the following:
   a Public Land Mobile Network, PLMN,
   a list of PLMNs,
   a tracking area identity, ID,
   a list of tracking area IDs,
   a virtual New Radio, NR, Cell Global Identifier, NCGI, identifier,
   an identifier associated with an access point in the wireless communication network,
   an identifier associated with a reference device,
   an identifier associated with a transmit and reception point, TRP.

In accordance with embodiments, when obtaining the information for determining the NW generated UE position, the NW entity is to receive from the UE
a message including the UE position and the information, or
a first message including the UE position and a second message including the information.

In accordance with embodiments, the NW entity is to verify the received UE position to be correct or acceptable in case one or more of the following applies:
the UE position and the NW generated UE position match,
the UE position is within a predefined range from or around the NW generated UE position,
the UE position is within a geographical area identified by the NW generated UE position,
at least one measurement made by the network entity or by another network entity on one or more signals transmitted by the UE is within a certain range of an expected measurement.

In accordance with embodiments, the NW entity is to verify the received UE position to be correct or acceptable in case the measurement equals the expected measurements plus/minus a predefined error.

In accordance with embodiments, the at least one measurement comprises one or more of the following:
a time of arrival, ToA, measurement,
a receive-transmit, Rx-Tx, time difference measurement,
a carrier phase measurement,
a Doppler shift measurement,
an angle of arrival, AoA, measurement,
an angle of departure, AoD, measurement,
a Reference Signal Time Difference, RSTD, measurement,
a Reference Signal Received Power, RSRP, measurement
a Round Trip Time, RTT, measurement, and
   the network entity or the other network entity comprises one or more of the following:
a gNB,
a satellite,
a NTN gateway,
a terrestrial TRP.

In accordance with embodiments, in case the wireless communication network includes as NTN components one or more satellites, like satellites of a GNSS or NTN network, the at least one measurement comprises one or more time variant measurements from a single satellite or from multiple satellites, e.g., one or more of the following:
a change in the measured range from the UE to the satellite,
a change in a measured Doppler shift,
a change in a measured angle from the satellite to the UE.

In accordance with embodiments, the NW entity is to indicate a reliability of the NW generated UE position or the verified UE position, e.g., a reliability level or a verification level associated with the UE position, e.g. with each reliability level or verification level mapping to a certain combination of accuracy in vertical direction and/or horizontal direction and/or statistical variation and/or the verification method used.

In accordance with embodiments, the NW entity is to request from the UE a new UE positon, e.g., a position with a higher resolution, in case a reliability of the verified position is below a certain threshold.

In accordance with embodiments,
the NW entity is to verify the UE position for selecting a Public Land Mobile Network, PLMN, or an Access and Mobility Management Function, AMF, to which the UE is to connect,
responsive to verifying the UE position, the NW entity is to send an initial UE message and registration request to one of the AMF belonging to the PLMN selected by the UE, and
responsive to not verifying the UE position, the NW entity is to reject a registration request from the UE and inform the UE that the UE is not allowed to register with the PLMN based on the UE location, wherein the NW entity may optionally also specify how long the UE needs to wait before trying again and may optionally indicate the accuracy requirement the UE needs to report the UE position with.

In accordance with embodiments, the NW entity is to verify the UE position for one or more clients, like another NW entity, e.g., a NG-RAN node, an AMF or a LMF, or the UE or to any Location Services, LCS, client, and wherein the NW entity is to provide a location report indicating that the UE position is verified, e.g., meets a certain verification level, or is not verified, e.g., does not meet the certain verification level.

In accordance with embodiments,
the wireless communication network comprises a radio access network, RAN, including the one or more NTN components, and a core network, CN, and
the NW entity is
   a RAN entity located in the RAN, e.g., at a RAN node, like a gNB or a eNB, serving a NTN gateway, or at one or more of the NTN components, or
   a core network, CN, entity, in the CN, e.g., in the form of a Location Management Function, LMF.

In accordance with embodiments, the NW entity is to send or is to cause another NW entity to send to the UE assistance data and/or a measurement request, the assistance data and/or the measurement request indicating to the UE one or more of the following:
signals to be measured by the UE, e.g., downlink reference signals, like Demodulation Reference Signals, DMRSs, Positioning Reference Signals, PRSs, or sidelink reference signals, or Global Navigation Satellite System, GNSS, signals, or signals of a terrestrial beacon system,
one or more configurations for transmitting one or more reference signals,
one or more configurations for reporting the one or more measurements.

In accordance with embodiments, the NW entity is to receive from another NW entity, like a LMF or an Operation and Maintenance, O&M, mechanism, or from an operator of the NTN components, assistance data, the assistance data supporting the NW entity to determine and/or verify the NW generated UE position.

### Aspect 1

### Determining/Verifying the UE Position by Means of Redundant GNSS Satellites

In accordance with embodiments, the NW entity is to
receive from the UE the one or more measurements of the one or more ranges between the UE and the at least one satellite of the GNSS, and
determine and/or verify the NW generated UE position using the one or more ranges.

In accordance with embodiments, the NW entity is to
compute a plurality of different positions, and
verify the received UE position using a statistical variance of the computed positions around a mean value.

In accordance with embodiments, the received UE position is verified when the statistical variance of the computed positions around the mean value is below a certain threshold, and wherein the certain threshold may depend on the Public Land Mobile Network, PLMN, to which the UE is to attach or is attached.

In accordance with embodiments, the NW entity is to send or is to cause another NW entity to send to the UE assistance data supporting the UE to receive GNSS signals.

### Aspect 2

### Determining/Verifying the UE Position Using Combination of GNSS and NTN Satellite

In accordance with embodiments, the NW entity is to
receive from the UE
   one or more first measurements of the one or more ranges between the UE and the at least one satellite of the GNSS, and
   one or more second measurements associated with the downlink,
obtain one or more third measurements associated with the uplink,
determine and/or verify the NW generated UE position using the one or more first, second and third measurements.

In accordance with embodiments, the NW entity is to receive from the UE a difference between a GNSS time and a UE time and/or a timing advance.

In accordance with embodiments, the NW entity is to receive from the UE a measurement report including, e.g., in case of a transparent satellite payload, one or more second measurements associated with the downlink, e.g., one or more of the following:
a receive-transmit, Rx-Tx, time difference between a time the UE received a DL reference signal and a time the UE sent out an UL reference signal,
a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values.

In accordance with embodiments,
the NW entity is located on the ground, like in a NTN gateway, e.g., in case of a transparent satellite payload, or on the NTN component, like in a satellite, e.g., in case of a regenerative satellite payload, and
the NW entity is to obtain one or more third measurements associated with the uplink, e.g., one or more of the following:
   a receive-transmit, Rx-Tx, time difference between a time the NW entity or the further NW entity, like a NTN Gateway or an antenna connector of a TRP, received an UL reference signal and a time the NW entity or the further NW entity sent out a DL reference signal,
   a receive time of an UL reference signal or a quality corresponding to the receive time, like a ToA or a phase,
   a difference in receive time between first and second reference signals, like a Reference Signal Time Difference, RSTD, between two UL reference signals, UL-RSs,
   one or more Doppler values.
   Angle of Arrival values

In accordance with embodiments, in case of a transparent NTN component payload, an influence of a feeder link is removed from the one or more second and third measurements, e.g., by subtracting from the one or more second and third measurements respective measurements on the feeder link.

In accordance with embodiments,
the DL reference signal may be any one of the following:
   a Synchronization Signal Block, SSB,
   a downlink Positioning Reference Signals, DL-PRS, transmitted by the NTN component,
   a Channel-State Information Reference Signal, CSI-RS,
   any Pseudo Noise, PN, sequence or one or more orthogonal sequences, like a Gold code, and
the UL reference signal may be any one of the following:
   a Physical Random Access Channel, PRACH, preamble,
   a Sounding Reference Signal, SRS, or a SRS for positioning,
   a Demodulation Reference Signal, DMRS,
   a Phase Tracking Reference Signal, PTRS,
   any Pseudo Noise, PN, sequence or one or more orthogonal sequences, like Zadoff Chu Sequences.

In accordance with embodiments, the NW entity is to receive from the UE a measurement report including:
one or more of range measurements and/or range difference measurements and/or angle measurements and/or Doppler values to the only NTN component, and
one or more measurements of one or more ranges between the UE and at least one satellite of a Global Navigation Satellite System, GNSS, like a ToA, optionally corrected, e.g. by Real-Time Kinematics, RTK, Network-Real-Time Kinematics, N-RTK, Precise Point Positioning, PPP, Precise Point Positioning-Real-Time Kinematics, PPP-RTK, Space State Representation, SSR.

### Aspect 3

### Determining/Verifying the UE Position Using RTT to Serving NTN and RSTD to Other NTN

In accordance with embodiments, the NW entity is to
receive from the UE one or more first measurements associated with the downlink,
obtain one or more second measurements associated with the uplink,
determine and/or verify the NW generated UE position using the one or more first and second measurements.

In accordance with embodiments, the NW entity is to receive from the UE a measurement report including one or more of the following first measurements associated with the downlink:
a receive-transmit, Rx-Tx, time difference between a time the UE received a DL reference signal and a time the UE sent out an UL reference signal, a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values.

In accordance with embodiments,
the NW entity is located on the ground, like in a NTN gateway, e.g., in case of a transparent satellite payload, or on the NTN component, like in a satellite, e.g., in case of a regenerative satellite payload, and
the NW entity is to obtain one or more third measurements associated with the uplink, e.g., one or more of the following:
   a receive-transmit, Rx-Tx, time difference between a time the NW entity or the further NW entity, like a NTN Gateway or an antenna connector of a TRP, received an UL reference signal and a time the NW entity or the further NW entity sent out a DL reference signal,
   a receive time of an UL reference signal or a quality corresponding to the receive time, like a ToA or a phase,
   a difference in receive time between first and second reference signals, like a Reference Signal Time Difference, RSTD, between two UL reference signals, UL-RSs,
   one or more Doppler values.

In accordance with embodiments,
the DL reference signal may be any one of the following:
   a Synchronization Signal Block, SSB,
   a downlink Positioning Reference Signals, DL-PRS, transmitted by the NTN component,
   a Channel-State Information Reference Signal, CSI-RS,
   any Pseudo Noise, PN, sequence or one or more orthogonal sequences, like a Gold code, and
the UL reference signal may be any one of the following:
   a Physical Random Access Channel, PRACH, preamble,
   a Sounding Reference Signal, SRS, or a SRS for positioning,
   a Demodulation Reference Signal, DMRS,
   a Phase Tracking Reference Signal, PTRS,
   any Pseudo Noise, PN, sequence or one or more orthogonal sequences, like Zadoff Chu Sequences.

### Aspects 4/5

### Determining/Verifying the UE Position Using Combination of NTN Satellites and Terrestrial TRPs

### Determining/Verifying the UE Position Using Sidelink

In accordance with embodiments, the NW entity is to
receive from the UE one or more further measurements on one or more links between the UE and one or more a reference devices of the wireless communication system, and
determine and/or verify the NW generated UE position using in addition the one or more further measurements.

In accordance with embodiments, the NW entity is to
receive from the UE one or more measurements on one or more links between the UE and one or more a reference devices of the wireless communication system, and
determine and/or verify the NW generated UE position using the one or more ranges.

In accordance with embodiments, the one or more measurements include one or more of range measurements and/or range difference measurements and/or angle measurements and/or Doppler values for the link to the one or more reference devices.

In accordance with embodiments, the reference device comprises
a further NW entity, e.g., a transmit and reception points, TRP, like a gNB or a eNB, to which the UE connects using the Uu interface, or
a further device, e.g. a further user device or UE to which the UE connects using the sidelink interface (PC5).

### Determining/Verifying the UE Position Using Combination of NTN Satellites and Terrestrial TRPs

### Determining/Verifying the UE Position Using Sidelink

In accordance with embodiments,
the information for determining the NW generated UE position of the UE comprises a message from the UE, the message including an authentication codeword associated with one or more reference devices of the wireless communication system, like a terrestrial transmission and reception point, TRP, and
the NW entity is to determine and/or verify the NW generated UE position using the authentication codeword.

In accordance with embodiments, the reference device comprises
a further NW entity, e.g., a transmit and reception points, TRP, like a gNB or a eNB, to which the UE connects using the Uu interface, or
a further device, e.g. a further user device or UE to which the UE connects using the sidelink interface.

In accordance with embodiments, the NW entity is to configure the reference device to derive the authentication codeword and transmit the authentication codeword to one or more UEs in a vicinity of the reference device.

In accordance with embodiments, the NW entity is to receive from the reference device a further authentication codeword provided by the UE to the reference device.

In accordance with embodiments,
an authentication code and/or device identifier and/or a token is exchanged between the first UE and second UE,
the reference device is a further UE already been registered with the wireless communication network and/or the position of the further UE is already verified, and
the UE is initiating the registration with the wireless communication network and/or the NW entity is attempting to verify the UE's position.

### Aspect 6

Determining the Suitable PLMN and/or an AMF Based on the UE Reported Identifier

In accordance with embodiments, the NW entity is to
transmit to a user device, UE, positions and reference point identifiers of a plurality of reference points in the wireless communication network,
receive from the UE a reference point identifier of one reference point, the UE selecting the one reference point position using a UE position determined by the UE and indicating a geographical location of the UE,
determine and/or verify the position of the UE using a position of the one reference point for which the reference point identifier is received.

In accordance with embodiments, the UE computes the UE positon using a GNSS system and/or one or more other terrestrial wireless systems.

In accordance with embodiments, the reference point is
a point mapping to location of a reference device on the ground, or
a grid point denoting a virtual cell.

In accordance with embodiments, the virtual cells signaled to the UE have a larger radius towards away from the border (e.g. the middle of the country), with the radius becoming smaller towards the border.

In accordance with embodiments, a location of a virtual cells is signaled to the UE using one or more of the following: a start position of the plane containing the virtual cells, an end position of the plane containing the virtual cells, one or more gradients, a start cell ID, an end Cell ID and a mapping rules.

In accordance with embodiments, the reference device comprises
a further NW entity, e.g., a transmit and reception points, TRP, like a gNB or a eNB, to which the UE connects using the Uu interface, or
a further device, e.g. a further user device or UE to which the UE connects using the sidelink interface.

In accordance with embodiments, the NW entity is to
receive from the UE the UE position, and
the NW entity is to allow the UE to access a Public Land Mobile Network, PLMN, or an Access and Mobility Management Function, AMF, if the UE position is within a certain distance threshold of the reference point.

### Aspect 7

### Verifying the UE Location Based on Virtual Cell Based on RTT Between a UE and a Satellite.

In accordance with embodiments, the NW entity is to
receive from the UE the UE position or a reference point identifier of a certain reference point, the UE position determined by the UE and indicating a geographical location of the UE, the UE selecting the certain reference point position from a plurality of reference point using the UE position,
receive from the UE one or more measurements associated with the downlink,
verify the received position using the one or more measurements.

In accordance with embodiments, the NW entity is to receive from the UE a measurement report including one or more of the following first measurements associated with the downlink:
a receive-transmit, Rx-Tx, time difference between a time the UE received a DL reference signal and a time the UE sent out an UL reference signal,
a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values, and
   the NW entity is to determine a range or distance between the UE position or a position associated with the certain reference point and the NTN component, and verify the received positon if it is within a predefined threshold.

### General

In accordance with embodiments, the NTN component includes one of more of
a spaceborne vehicle, like a satellite or a space vehicle at a specific altitude and orbital period or plane, e.g., a low earth orbit, LEO, a medium earth orbit, MEO, a geosynchronous orbit, GSO, a geostationary orbit, GEO, or a high earth orbit, HEO, and
an airborne vehicle, like an unmanned aircraft system, UAS, e.g., a tethered UAS, a lighter than air UAS, LTA, a heavier than air UAS, HTA and a high altitude UAS platforms, HAPs.

### Of UE Providing Certain Information to NW Entity for Determining UE Positon in the NTN

The present invention provides a user device, UE, for a wireless communication network, the wireless communication network including one or more non-terrestrial network, NTN, components, like an airborne vehicle or a spaceborne vehicle,
wherein the UE is to provide one or more of the following information:
   information for determining and/or verifying a network, NW, generated UE position of the UE at a network, NW, entity of the wireless communication network, and/or
   a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

In accordance with embodiments, the UE is to provide the information during a registration procedure for registering with the wireless communication, e.g., together with the attach request signaled to a NW entity of the wireless communication network.

In accordance with embodiments, the UE is to add the information to the RRCSetupComplete message and/or is to convey the information in an additional dedicated message to be transmitted before or after the RRCSetupComplete message.

In accordance with embodiments,
during a registration with the wireless communication network, the UE is to provide an altered version of the UE position, e.g., a UE position having added thereto an offset and/or a rotation, and
in case UE is allowed to access the wireless communication network, provide to the core network, e.g., after AS security is enabled, one or more reverse transformation parameters allowing the NW entity is to retrieve a true UE position from the altered version of the UE position by undoing the alteration done by the UE.

In accordance with embodiments, the information for determining the NW generated UE position of the UE comprises one or more of the following:
a report of one or more measurements by the UE,
a report of coordinates of a reference point in the wireless communication network that is less than a predefined distance from the UE or coordinates of the UE location as computed by the UE.
one or more UL reference signals.

In accordance with embodiments, the one or more measurements comprise one or more of the following:
one or more measurements of one or more ranges between the UE and at least one component of the separate positioning system used by the UE to determine its position,
one or more measurements of a range, like time of flight, ToF, or a range difference, like time difference of arrival, TDOA, between the one or more NTN components,
one or more measurements of a range, like ToF, or a range difference, like TDOA, between one or more reference devices, like a terrestrial transmission and reception point, TRP,
one or more measurements of a range, like time of flight, ToF, between the UE and a first entity in the RAN and one or more measurements of a range difference, like TDOA, between the UE and at least a second entity in the RAN,
a receive-transmit, Rx-Tx, time difference between a time the UE received a DL reference signal and a time the UE sent out an UL reference signal,
a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values.

In accordance with embodiments, the first entity in the RAN and the second entity in the RAN comprises:
one or more TRPs of one or more terrestrial networks,
one or more access network entities of one or more non-terrestrial networks, like one or more NTN satellites,
one or more terrestrial beacon systems,
one or more reference devices in the wireless communication network.

In accordance with embodiments, the UE is to receive assistance data and/or a measurement request, the assistance data and/or the measurement request indicating to the UE one or more of the following:
signals to be measured by the UE, e.g., downlink reference signals, like Demodulation Reference Signals, DMRSs, Positioning Reference Signals, PRSs, or sidelink reference signals, or Global Navigation Satellite System, GNSS, signals, or signals of a terrestrial beacon system,
one or more configurations for transmitting one or more reference signals,
one or more configurations for reporting the one or more measurements.

In accordance with embodiments, the wireless communication network provides positions and reference point identifiers of one or more reference points in the wireless communication network, and the UE is to report as its UE position the position of or an authentication code associated with and obtained from the reference point that is less than a predefined distance from the UE, e.g., the reference point among a plurality of reference points to which the UE is closest.

In accordance with embodiments, the UE is to transmit
a message including the UE position and the information, or
a first message including the UE position and a second message including the information.

### System

The present invention provides a wireless communication system, comprising:
one or more non-terrestrial network, NTN, components, and
one or more network, NW, entities in accordance with embodiments of the present invention and/or one or more user devices, UEs, in accordance with embodiments of the present invention.

In accordance with embodiments, the NW entity and the further NW entity comprises one or more of the following: a macro cell base station, or a small cell base station, or a central unit of a base station, or a distributed unit of a base station, or a road side unit, RSU, or an integrated access and backhaul node, IAB, or a UE, or a group leader, GL, or a relay or a remote radio head, or an AMF, or an MME, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

In accordance with embodiments, the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader, GL, UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### Methods

The present invention provides a method for operating a network, NW, entity for a wireless communication network, the wireless communication network including one or more non-terrestrial network, NTN, components, like an airborne vehicle or a spaceborne vehicle, the method comprising:
obtaining information for determining a network, NW, generated UE position of a user device, UE, and
determining and/or verifying the NW generated UE position using the obtained information.

The present invention provides a method for operating a user device, UE, for a wireless communication network, the wireless communication network including one or more non-terrestrial network, NTN, components, like an airborne vehicle or a spaceborne vehicle, the method comprising:
providing, by the UE, one or more of the following information:
   information for determining and/or verifying a network, NW, generated UE position of the UE at a network, NW, entity of the wireless communication network, and/or
   a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

### Computer Program Product

Embodiments of the present invention provide a computer program product comprising instructions which, when the program is executed by a computer, causes the computer to carry out one or more methods in accordance with the present invention.

Embodiments of the present invention provide approaches that allow, e.g., in the above mentioned scenarios in which a UE location is needed for registering a UE with a core network or the UE location is needed for regulatory use cases, like the mentioned emergency call, to determine the UE position or location within a NTN at the network side to obtain a network, NW, generated UE position, or to verify at the network side location information provided by the UE, also referred to as the UE reported UE position, using a NW generated UE position so as to determine the UE position, e.g., with a needed or desired reliability.

Embodiments of the present invention provide for an adjustment of the UE's registration procedure to enable the NTN to determine a UE position and/or to verify a UE positon computed and reported by the UE itself, so that the access network, like the NG-RAN network, may select a suitable PLMN and/or a network node for mobility management such as the AMF.

Embodiments of the present invention enable a network entity of the NTN to compute a UE positon at the network side, also referred to in the following as the NW generated UE position, and/or verify a position computed and reported by the UE, also referred to in the following as the UE reported UE position as to obtain a network verified UE position. The process of computing the NW generated UE position and/or verifying the UE reported UE position may take place in the LMF located in the core network or in the NG-RAN node. In accordance with embodiments, when the entity is located in the NG-RAN node it may also be referred to as a positioning computing and coordinating entity, PCCE. The network verified or network generated UE position may be used, in accordance with embodiments, for selecting an AMF or a PLMN. Also, in accordance with further embodiments, the network verified or network generated UE position may be used in applications or use cases where the UE is already connected to the network, e.g., in case of emergency calls, a lawful interception, a localization, network operation, meeting regulatory aspects responding to the UE location and the like.

In accordance with embodiments of the present invention, the NW generated UE position may be obtained on the basis of measurements. Such measurements may be performed at the network side, e.g., by the NW entity that actually determines/verifies the UE position and/or by one or more further NW entities that report the measurement to the NW entity that actually determines/verifies the UE position. The measurements may also be obtained from the UE. In accordance with other embodiments, the inventive approach provides a UE position by creating a NW generated and/or NW verified UE position without relying on a UE reported UE position.

In accordance with embodiments of the present invention, the UE reported position or information pertaining to the position reported by the UE may be verified as plausible, if an expected measurement of at least one physical quantity (e.g. RSTD, RTT, Rx-TX time difference, Doppler, Angle of Arrival/Angle of Departure, RSRP) is within a certain variation from the expected value of the measurement for a given link, like the downlink and/or the uplink. For example, the NW entity may verify a received UE position to be correct or acceptable in case the measurement equals the expected measurements plus/minus a predefined error. The measurement may comprise one or more of the following: a time of arrival, ToA, measurement, a receive-transmit, Rx-Tx, time difference measurement, a carrier phase measurement, a Doppler shift measurement, an angle of arrival, AoA, measurement, an angle of departure, AoD, measurement, a Reference Signal Time Difference, RSTD, measurement, a Reference Signal Received Power, RSRP, measurement, a Round Trip Time, RTT, measurement. The measurement may be made by the network entity or by a further network entity, like one or more of the following: a gNB, a satellite, a NTN gateway, a terrestrial TRP.

In accordance with further embodiments, the UE position may be determined at the NTN without performing measurements. The UE may signal information associated with one or more reference locations or reference points in the NTN which, e.g., indicate that the UE is at or within a certain range around a reference location/point. On the basis of this information, the NTN, which knows the position of the reference location/point, may determine where the UE is located without relying on specific measurements provided by the UE or performed by the NTN.

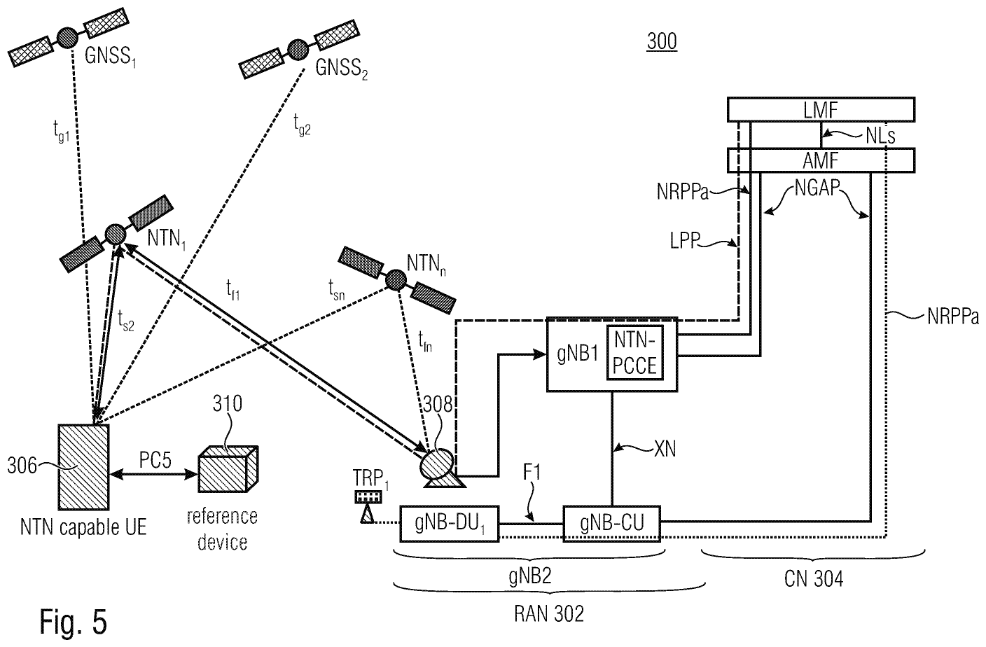

Embodiments of the present invention may be implemented in a wireless communication system including NTN components. FIG. 5 is a schematic representation of a wireless communication system for implementing embodiments of the present invention, and illustrates a wireless communication network or NTN 300 including one or more NTN entities or components. FIG. 5 depicts various entities involved in determining/verifying a UE position at the network side so that the network may determine whether a UE position is reliable enough to be used, e.g., for an application for which the position is requested. It is noted that, dependent on the respective embodiments, only a subset of the entities described with reference to FIG. 5 may be employed for the verification/generation of the UE position at the network side. In other words, not all of the entities shown in FIG. 5 may be employed but only one or more of the depicted entities. The network 300 comprises the RAN 302, the CN 304 and the NTN components, e.g., the satellites NTN₁ to NTNₙ. A NTN capable UE 306 is connected via one or more of the satellites NTN₁ to NTNₙ to the RAN 302. In the embodiment of FIG. 5, UE 306 is connected to the RAN 302 via the satellite NTN₁. UE 306 is connectable to the satellites NTN₁, to NTNₙ via respective first links tₛ₁ to tₛₙ, also referred to as service links operating at a frequency fₛ. The satellites, in turn, are connected to a gateway 308 of the RAN 302 via the respective links f_{f1} to f_{fn}, also referred to as feeder links operating at a frequency f_{f}. The gateway 308 is connected to one or more RAN nodes, like gNB₁, gNB₂. In the example of FIG. 5, the gateway 308 is connected to gNB₁. gNB₂ may be a distributed gNB including the distributed unit gNB-DU and the central unit gNB-CU connected over the F1 interface. Further, the gNBs of the RAN 302 may be connected to each other via a backhaul connection, like the XN interface. In accordance with other embodiments, a base station or gNB may also be provided on board of the NTN satellites.

The gNBs are connected with the CN 304, more specifically, to the AMF via the Next Generation Application Protocol, NGAP, interface, and the AMF may be connected to a location management function, LMF, via the NLs interface point. In the embodiment of FIG. 5, the gNB₁ may include a network entity, referred to as NTN-PCCE, for determining or verifying a location of UE 306 either when attaching to the network for the first time, e.g., during initial access, or when a certain application or service needs a location indication of the UE with a certain reliability. The NTN PCCE may operate in accordance with embodiments of the present invention for determining/verifying a UE position. In accordance with other embodiments, the inventive functionality may also be provided in the LMF, i.e., the may operate in accordance with embodiments of the present invention for determining/verifying a UE position. The NTN PCCE is connected to the core network via the NR Positioning Protocol A, NRPPₐ interface, and the LMF is connected to the gateway via the LTE Positioning Protocol, LPP, protocol interface.

FIG. 5 further illustrates two satellites of the global navigation satellite system, namely satellites GNSS1 and GNSS2 to which UE 306 may be connected via a GNSS unit over the links t_{g1} and t_{g2}. UE 306 may determine a location at which it is currently located, like a geographical location on the surface of the earth, using the GNSS satellites. In other embodiments, other external systems may be used, like the above mentioned systems, i.e., also external, terrestrial systems may be provided allowing UE 306 to calculate a location of the UE on its own within a certain geographical area.

UE 306 may be connected to a reference device 310, for example, by a sidelink connection using the PC5 interface. The system 300 may also include one or more terrestrial access points, like TRP1 connected to gNB₂. The term TRP in the figure refers to a transmission and reception point for transmitting and receiving NR or LTE signals at a network side or to a terrestrial beacon system.

The system or network 300 of FIG. 5, UE 306, the NTN-PCCE and the LMF may operate in accordance with embodiments of the invention described herein.

In accordance with embodiments, a network entity is provided, for example, the NTN-PCCE or the LMF in FIG. 5, determines a UE location or verifies location information reported by the UE, for example, the UE position. In accordance with embodiments, also the UE velocity or UE time may be verified, e.g., in addition to the verification of the UE position. For example, the instantaneous velocity of the UE may be estimated, given the UE location is available. If a reliable and precise NW based location is available, then this location may be used. Otherwise, the UE reported location is used in the first instance for determining the velocity. Once a UE location is known, an expected Doppler shift for the signal received at the satellite may be compensated and the remaining Doppler may be used for estimating the UE velocity. Alternatively, positions from past instants may be used for an estimation of the UE velocity.

The network entity may compute the UE location to obtain the NW generated UE position, for example, by using one or more measurements performed at UE 306 and/or at the network. The NW side measurements may be made by the NTN-PCE or by the LMF or by another entity in the network 300 which reports the measurements to the NTN-PCE or to the LMF. The measurements made at UE 306 are reported to the NTN-PCE or the LMF. The network entity may obtain the NW generated UE position also by determining that UE 306 is at or within a pre-defined range of the reference device 310 or the TRP1 in FIG. 5 and use the location of the reference device or the TRP1 as the UE location. The network may determine the UE position without relying on any location information reported by the UE. In accordance with embodiments, the NW generated UE position may be used for verifying the UE reported UE position obtained by UE 306 on its own.

In accordance with further embodiments, the network entity determining and/or verifying the UE position may receive assistance and/or configuration information from another network entity. For example, in case the entity is at the gNB, the LMF may provide the assistance and/or configuration information. In accordance with other embodiments, the assistance and/or configuration information may be provided by a positioning integrity computing entity either inside or outside the network, by an external data base, from the Operation & Maintenance, O&M, entity or from interfaces to external systems, like GNSS monitoring stations.

In accordance with embodiments, the network entity determining and/or verifying the UE position may be located at the NG-RAN node, like the NTN-PCCE in FIG. 5. The NG-RAN node may be a gNB or an eNB either serving the NTN gateway 308 in case the satellites NTN₁ to NTNₙ process transparent payload, or the network entity may be located at the satellite in case of processing regenerative payload. The determination/verification of the UE position may be performed also in situations in which UE 306 is not yet attached to the core network, for example the verification/determination may be performed on the network side to confirm that a location of the UE allows for a connection to a PLMN selected by the UE or not. In case UE 306 is already connected to the network, the network entity provided at the RAN allows determining/verifying a UE position to be used for certain services or use cases, like emergency calls.

In accordance with other embodiments, the entity may the LMF of the core network 304, for example, the core network of the PLMN the UE is registered with.

In accordance with embodiments, the network entity determining/verifying the UE position may provide assistance data and/or configuration data to UE 306. For example, the assistance data, also referred to as signaling information, may indicate to UE 306 signals to be measured by the UE. The signals to be measured my include reference signals, like downlink reference signals, e.g., Demodulation Reference Signals, DMRSs or Positioning Reference Signals, PRSs, or sidelink reference signals or GNSS signals or terrestrial beacon system signals. In situations in which UE 306 attaches to the network, the information is provided by the NR-RAN node, for example, by employing a unicast, multicast or broadcast signaling. In case UE 306 is already attached to the network the information may be provided by the LMF, for example, via the LPP protocol or by sending a positioning SIB, posSIB.

In accordance with embodiments, the network may determine/verify the UE location using measurements provided by the UE and/or measurements generated at the NG-RAN, for example, by the determination/verification entity itself or by other entities of the RAN which provide the measurement results to the determination/verification entity. As mentioned above, to support the UE to provide the measurements, assistance data, AD, may be provided so as to inform the UE, for example, about reference signals to be monitoring and measured, as well as to provide configurations for transmitting reference signals to be measured at the RAN side as well as configuration information concerning the reporting of the measurements. For determining/verifying a position of UE 306, in accordance with embodiments, one or more of the following measurements may be employed:
one or more measurements of one or more ranges between the UE and at least one satellite of a Global Navigation Satellite System, GNSS, used by the UE to determine the UE position,
one or more measurements of a range, like time of flight, ToF, or a range difference, like time difference of arrival, TDOA, between the one or more NTN components,
one or more measurements of a range, like ToF, or a range difference, like TDOA, between one or more reference devices, like a terrestrial transmission and reception point, TRP,
a combination one or more measurements of a range, like ToF, and/or a range difference, like TDOA, using one or more signals transmitted and/or received by at least a first system and at least a second system,
one or more measurements of a range, like time of flight, ToF, between the UE and a first entity in the RAN and one or more measurements of a range difference, like TDOA, between the UE and at least a second entity in the RAN.

In accordance with embodiments, the above mentioned first and second systems may include the following:
a GNSS,
one or more TRPs of one or more terrestrial networks,
one or more integrated access and backhaul nodes, IABs,
one or more access network entities of one or more non-terrestrial networks, like one or more NTN satellites,
one or more terrestrial beacon systems,
one or more reference devices in the wireless communication network, and

In accordance with embodiments, the above mentioned first and second entities in the RAN may include the following:
one or more TRPs of one or more terrestrial networks,
one or more access network entities of one or more non-terrestrial networks, like one or more NTN satellites,
one or more terrestrial beacon systems,
one or more reference devices in the wireless communication network.

In accordance with embodiments, the UE position, either the one determined at the network or the UE position reported by the UE and verified by the network may be associated with a certain reliability. In accordance with embodiments, a UE position, either determined at the network or verified by the network, may be associated with one of a plurality of NTN positioning reliability levels. For example, seven reliability levels may be applied, for example the seven reliability levels defined for terrestrial applications in 3GPP TS 22.261. The determining/verifying entity may evaluate the reliability level of the position. The reliability level may comprise a horizontal accuracy, a vertical accuracy, as specified, for example, into 3GPP TS 22.071. The positioning levels from 3GPP TS 22.261 are as follows, and the positioning levels may be defined similarly for NTN as well:

| | | | | | | Coverage, environment of use and UE | | |
|---|---|---|---|---|---|---|---|---|
| | | | | | | velocity | | |
| | | Accuracy | | | | | 5G enhanced | |
| | | (95% | | | | | positioning | |
| | Absolute(A) | confidence | | | | | service area | |
| Positioning | or | level) | | Positioning | Positioning | 5G | (note 2) | |
| service | Relative(R) | Horizontal | Vertical | service | service | positioning | Outdoor and | |
| level | positioning | Accuracy | Accuracy | availability | latency | service area | tunnels | Indoor |
| 1 | A | 10 m | 3 m | 99% | 1 s | Indoor-up to | NA | Indoor- |
| | | | | | | 30 km/h | | up to 30 |
| | | | | | | Outdoor | | km/h |
| | | | | | | (rural and | | |
| | | | | | | urban) up to | | |
| | | | | | | 250 km/h | | |
| 2 | A | 3 m | 3 m | 99% | 1 s | Outdoor | Outdoor | Indoor- |
| | | | | | | (rural and | (dense urban) | up to 30 |
| | | | | | | urban) up to | up to 60 km/h | km/h |
| | | | | | | 500 km/h for | Along roads up | |
| | | | | | | trains and up | to 250 km/h | |
| | | | | | | to 250 km/h for | and along | |
| | | | | | | other vehicles | railways up to | |
| | | | | | | | 500 km/h | |
| 3 | A | 1 m | 2 m | 99% | 1 s | Outdoor | Outdoor | Indoor- |
| | | | | | | (rural and | (dense urban) | up to 30 |
| | | | | | | urban) up to | up to 60 km/h | km/h |
| | | | | | | 500 km/h for | Along roads up | |
| | | | | | | trains and up | to 250 km/h | |
| | | | | | | to 250 km/h for | and along | |
| | | | | | | other vehicles | railways up to | |
| | | | | | | | 500 km/h | |
| 4 | A | 1 m | 2 m | 99.9% | 15 ms | NA | NA | Indoor- |
| | | | | | | | | up to 30 |
| | | | | | | | | km/h |
| 5 | A | 0.3 m | 2 m | 99% | 1 s | Outdoor | Outdoor | Indoor- |
| | | | | | | (rural) up to | (dense urban) | up to 30 |
| | | | | | | 250 km/h | up to 60 km/h | km/h |
| | | | | | | | Along roads | |
| | | | | | | | and along | |
| | | | | | | | railways up to | |
| | | | | | | | 250 km/h | |
| 6 | A | 0.3 m | 2 m | 99.9% | 10 ms | NA | Outdoor | Indoor- |
| | | | | | | | (dense urban) | up to 30 |
| | | | | | | | up to 60 km/h | km/h |

| | | | | | | |
|---|---|---|---|---|---|---|
| 7 | R | 0.2 m | 0.2 m | 99% | 1 s | Indoor and outdoor (rural, urban, dense |
| | | | | | | urban) up to 30 km/h |
| | | | | | | Relative positioning is between two UEs |
| | | | | | | within 10 m of each other or between one |
| | | | | | | UE and 5G positioning nodes within 10 m of |
| | | | | | | each other (note 3) |

NOTE 1:
The objective for the vertical positioning requirement is to determine the floor for indoor use cases and to distinguish between superposed tracks for road and rail use cases (e.g. bridges).
NOTE 2:
Indoor includes location inside buildings such as offices, hospital, industrial buildings.
NOTE 3:
5G positioning nodes are infrastructure equipment deployed in the service area to enhance positioning capabilities (e.g. beacons deployed on the perimeter of arendezvous area or on the side of a warehouse).

In accordance with embodiments, the UE position, either the one determined at the network or the UE position reported by the UE and verified by the network may be associated with a certain reliability. In accordance with embodiments, a UE position, either determined at the network or verified by the network, may be associated with one of a plurality of verification levels, with each verification level comprising a reliability and a certain horizontal and vertical accuracy. The verification level may be mapped to the level of statistical variation on a position generated or verified for the UE. It may depend on the number of different measurements made by the NW entity and/or by the UE and their statistical variation from the respective expected values.

For example, if the position is computed by the NW entity based on RTT measurements to a serving-satellite and fusing at least one of the UE reported GNSS measurements, in case the UE reported position is within centimeter level accuracy, then it has the highest verification level.

In another example, the parameters determining the computation of the verification level may be implementation specific, but the determined verification level value itself may represent a probability that the position is true within a certain margin. For example, a value of 1 means the position may be trusted by NW entities beyond doubt to be within a certain margin. A value of 0 implies, the UE is unlikely to be within the margin of the UE reported position.

In accordance with embodiments, the NW entity may request from the UE a new UE positon, e.g., a position with a higher resolution, in case a reliability of the verified position is below a certain threshold.

In accordance with embodiments, UE 306 may send a location report. The location report configuration may be determined by the UE responsive to assistance or configuration data received from the network. In case of verifying a UE reported UE position, the UE may send its actual location, like its geographical location, e.g., by indicating a latitude, a longitude and an altitude.

In accordance with other embodiments, the location report from the UE may include information derived from the UE's location and from assistance data which, in such embodiments, may refer to the location of one or more virtual points, e.g., the above mentioned reference locations or reference points. The location report may indicate how the one or more virtual points are associated to one or more of the following:
a Public Land Mobile Network, PLMN,
a list of PLMNs,
a tracking area identity, ID,
a list of tracking area IDs,
a virtual New Radio, NR, Cell Global Identifier, NCGI, identifier,
an identifier associated with an access point in the wireless communication network,
an identifier associated with a reference device,
an identifier associated with a transmit and reception point, TRP.

For example, an information element, IE, may signal the position in form of a latitude, a longitude and an altitude, and an associated PLMN. This information may be carried in one of the system information (SI) messages and/or may be communicated to the UE by RRC signaling and/or LPP signaling. The information associating the virtual point and the PLMN may indicate that the PLMN is within a range of 2 kilometers of the virtual point, or within a range of 2 kilometers with a 30° counterclockwise rotation from the geographical north of the virtual point. When the UE selects such a virtual point and its identifier, the location of the UE is reported with a certain accuracy thereby allowing the UE to maintain privacy by not reporting its exact location, for example in a situation in which the UE is currently attaching to the network with the AS security not yet activated. In accordance with other embodiments, the UE may actually distort its position based on one of the UE identifiers for reporting, for example by applying an angular rotation around the virtual point selected by the UE and reporting the resultant location.

Embodiments of the present invention provide a user device, UE, providing information for a network, NW, entity for a network including NTN components, like a satellite, for determining the NW generated UE position. The UE may provide one or more of the following information:
information for determining a network, NW, generated UE position of the UE at a network, NW, entity of the wireless communication network, and/or
a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

In accordance with embodiments, UE 306 provides the information during a registration procedure for registering with the wireless communication, e.g., together with the attach request signaled to a NW entity of the wireless communication network. For example, the information is added to the RRCSetupComplete message and/or is conveyed in an additional dedicated message transmitted before or after the RRCSetupComplete message. The UE may report one or more of the following:
a report of one or more measurements by the UE,
a report of coordinates of a reference point in the wireless communication network that is less than a predefined distance from the UE,
one or more UL reference signals.

The assistance data includes the configuration information of the DL RS the UE is expected to measure, configuration information of the UL RS the UE is expected to transmit, and is provided to the UE using one of the SIB messages. The configuration message includes at least information to derive a time-frequency allocation of REs (e.g. slot number, OFDM symbol start, length, transmission comb size, transmission comb offset) and a sequence to be used (e.g. type of orthogonal code, root sequence, cyclic shift). As a fallback, the UE may use the SSB as downlink reference signal and/or the PRACH as uplink reference signal. The UE may optionally indicate which of the reference signal and/or reference signal pair the UE has used for reporting measurement (e.g. in case of Tx-Rx-Delay).

Further details of the UE are described with reference to the following embodiments.

In the following embodiments of a network, NW, entity and a user device, UE for determining/verifying a UE location in accordance with the present invention are described.

### Determining/Verifying of a UE Position Using Range Measurements to Components of a Positioning System

In accordance with embodiments of the present invention, a position of UE 306 (see FIG. 5) may be determined or verified using range measurements obtained at UE 306 to respective components of a positioning system. The positioning system is separate from the NTN and allows UE 306 to determine its position or location, like its location or position within a certain area or on the surface of the earth. The positioning system is also referred to as a RAT-independent system and may include a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS. On the basis of range measurements to a plurality of transmitters provided by the positioning system the UE determines its location, like its geographical location either on the surface of the earth or within a certain area.

In the following, embodiments are described in more detail with reference to the A-GNSS as one example for a RAT-independent system used by UE 306 for determining its position. UE 306, on the basis of the signals from the GNSS satellites determines the ranges to the GNSS satellites and, on the basis of these ranges, determine its location. In accordance with embodiments, the UE reports the measured ranges to the plurality of GNSS satellites to the NTN so as to allow the NTN to compute or determine the UE position as the NW generated UE position at the network side. Measurements for more than four satellites may be used, and on the basis of such measurements, the network entity computing the position, like the NTN-PCCE of the LMF in FIG. 5 may compute a plurality of different positions and verify the received UE position using a spread of the computed positions around a mean value, like the variance. For example, n!/r!(n−r)! different positions may be computed, where n is the number of measurements from different satellites, and r is the number of subsets of measurements chosen for computing the position. The spread of the computed position around a mean value, for example around a variance value, may be used as a metric to determine whether the NW generated UE position is reliable or has a desired level of reliability or not. Since the NW entity computes position from redundant measurements, the computed position has a variance. For example, if five satellites are used, instead of four, then five different positions may be computed. If the signals are reliable, then these positions should have small variance, and if at least one signal is spoofed, then there will be more variance.

Thus, in accordance with the just described embodiment, the NTN is capable to determine a position of the UE, i.e. to provide a NW generated UE position, without the UE being fully attached to the network as the signals of the external positioning system are measured. No signaling in accordance with NR or LTE is needed.

In accordance with further embodiments, UE 306 may report its position as determined from the signals from the GNSS satellites to the network side, the UE reported UE position may by verified against the NW generated UE position. Thus, based on the NW generated UE position, the UE reported UE position may be considered to be correct or acceptable, for example to be at a certain reliability level, when the two positions match, differ by not more than a certain, predefined amount, or the UE reported UE position falls within an area defined by the NW generated position.

In accordance with embodiments, this approach may be employed either when a UE is attaching to the NTN so as to determine as to whether the UE is actually at a location at which it is allowed to connected to the selected PLMN. Also, in accordance with other embodiments, this process may be employed when the UE is already attached to the NTN and a certain use case, like an emergency call, needs to determine/verify the UE position again.

In accordance with embodiments, the process for determining/verifying a UE position may be implemented in the NTN-PCCE illustrated in FIG. 5. UE 306 may receive assistance data for reading GNSS signals. The assistance data may be provided by the NG-RAN node gNB1 which transmits the assistance data to the UE using, for example, one or more posSIBs. The NG-RAN node gNB1 may receive the assistance data from one or more LMFs via the NRPPA interface. In accordance with other embodiments, the UE may not receive any assistance data but acquire the needed information for obtaining the GNSS signals by decoding respective GNSS messages.

UE 306 computes a position of the UE using the measured ranges to the GNSS satellites and reports the position as well as the measured ranges in one or more messages from UE 306 to the NG-RAN node gNB1, e.g., when requesting a connection setup. The position and/or the measurement may be added to the RRCSetupComplete message 226 (see FIG. 3) or may be conveyed in a newly defined dedicated message transmitted either before or after the RRCSetupComplete message. The NTN-PCCE determines the UE position on the basis of the measurements indicating the ranges to the plurality of GNSS satellites and decides whether the position is reliable or not according to certain criteria. For example, multiple reliability levels may be provided for a UE accessing the NTN network, and each reliability level may map to a certain combination of accuracy in a vertical direction and/or in a horizontal direction and/or a spread.

The NTN-PCCE, in accordance with further embodiments, may verify a reported position, the UE position, against the NW generated UE position.

In accordance with embodiments, the network, NW, may indicate to the UE to report a location in accordance with certain characteristics, like a reliability level. For example, the network may request the location to have a certain granularity, like 2 kilometers, or a certain format, like the WTD 84 format, or a certain implicit location, for example the vicinity to a certain device, like the reference device 310.

In accordance with further embodiments, the above process may be implemented in the LMF. The network sends a RequestLocationInformation to UE 306 in which the network specifies at least one satellite, for example identified by the space vehicle ID, SVID, of the satellite system that is supported by the location server. The satellite system may be system used by the UE for calculating the UE position by its own, or it may be different satellite system which may also be accessed by the UE.

UE 306 reports the measurements for one or more satellites for the satellite system indicated by the LMF. In accordance with embodiments, the UE also provides the location information, like a position and/or a velocity and/or a time. The UE may use assistance data provided by the location server or the NG-RAN to make the measurements. On the basis of the received measurements, the LMF calculates or determines the NW generated UE position and decides whether the position is reliable or not according to certain criteria. For example, the LMF may partition the available measurements into at least two or more subsets and computes positions by using ToA from at least one subset. The location server may determine two or more estimates of positions and compare the results to an aggregate value of positions obtained. For example, the aggregate value of positions may be the mean of the position estimate.

In accordance with further embodiments, the LMF may verify a location information reported by the UE, against the NW generated UE position.

In the above embodiments, reference has been made to certain criteria on the basis of which the LMF or the NTN-PCCE determine whether the NW generated UE position is reliable or not. In accordance with embodiments, the criteria may comprise comparing whether the UE reported value of a position is within a certain interval of values determined by the network. There may be multiple reliability levels for a UE accessing the NTN network defined, where each reliability level maps to a certain combination of accuracy in a vertical direction and/or a horizontal direction or a spread. The LMF may indicate to a client that requested the location information the reliability level of the NW generated UE position. The client may be an application requesting the information about the position, running on the network or on the UE or any other device.

### Determining/Verifying a UE Position Using a Combination of the Positioning System and the NTN System

In accordance with further embodiments of the present invention, for determining the NW generated UE position, the network entity may not only rely on the measurements of signals associated with the positioning system, like the GNSS, but also measurements with reference to one or more NTN components, like NTN satellites, may be used for determining the NW generated UE position.

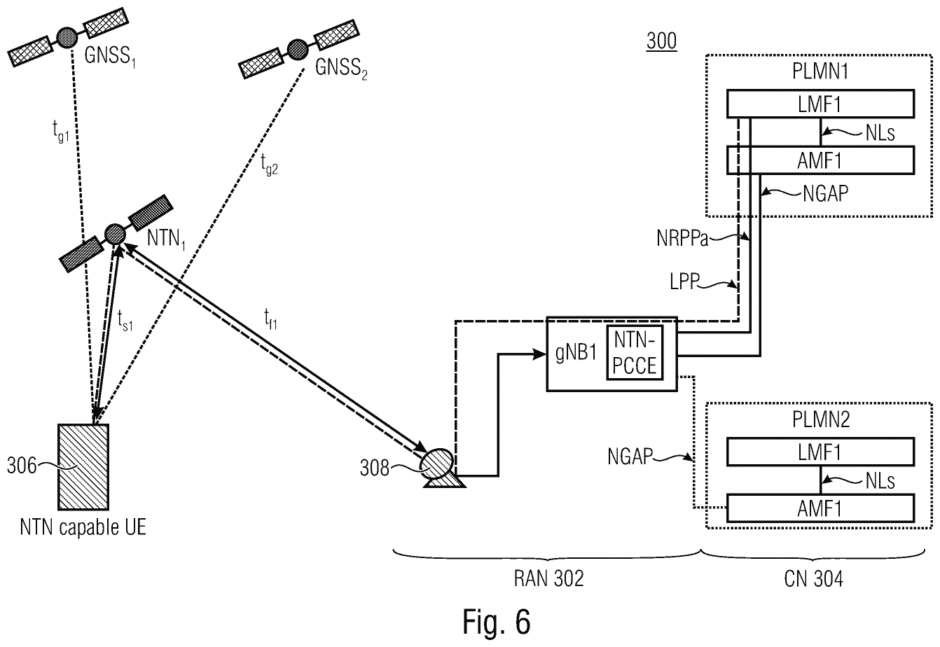

FIG. 6 illustrates an embodiment of the present invention determining/verifying the UE position using a combination of a GNSS and one or more NTN satellites. In FIG. 6, elements already described above with reference to FIG. 5 are not described again. UE 306 is assumed to be connected to RAN 302, more specifically to gNB1 via the gateway 308 and the satellite NTN₁. FIG. 6 also illustrates the satellites GNSS₁ and GNSS₂ of the GNSS on the basis of which UE 306 may determine its location. The core network 304 includes two public land mobile networks PLMN₁, PLMN₂ connected to gNB1 over the NGAP interface. UE 306 may request access to one of the PLMNs, and after determining/verifying the position of UE 306, the NTN-PCCE may allow UE 306 to attach to the desired PLMN₁, in case UE 306 is at a position associated with the selected PLMN₁. In FIG. 6, it is assumed that UE 306 intends to attach to PLMN₁ so that, in case the UE position is determined/verified at NTN-PCCE, for example during the attach request procedure 204 (see FIG. 3) the gNB1 selects PLMN₁ for UE 306. Procedures 204-212 are then performed between gNB1 and UE 306 and PLMN₁.

The verification of a UE reported UE location for the purpose of selecting a PLMN is now described. Initially, UE 306 may receive from NG-RAN node gNB1 assistance data regarding the GNSS signals to be measured. The assistance data may be received at the gNB1 from the LMFs of the PLMNs coupled to the gNB1, which, in turn, transmits the information to the UE, for example using the posSIBs. As mentioned above with regard to the preceding embodiments, the UE may acquire information for determining the GNSS signals in a standard mode by decoding GNSS messages.

The UE computes the UE position on the basis of the GNSS signals received and reports the UE position, as determined by the UE itself, and the measurements of the GNSS signals in one or more messages from UE 306 to the NG-RAN node gNB1, in which the NTN-PCCE resides. The measurements and/or the position may be added to the RRCSetupComplete message 226 or may be conveyed in a newly defined dedicated message transmitted either before or after the RRCSetupComplete message during the attach request 204.

In addition to the measurements regarding the positioning system, like the GNSS, measurements associated with the downlink from the RAN to UE 306, as well as measurements associated with the uplink from UE 306 to the RAN are provided to the NTN-PCCE. The NW entity may be located on the ground, like in a NTN gateway, e.g., in case of a transparent satellite payload, or on the NTN component, like in a satellite, e.g., in case of a regenerative satellite payload. For such measurements, the network may provide assistance data to the UE containing a configuration of the downlink reference signals transmitted to the UE and/or the uplink reference signals to be transmitted to by the UE. At the network side, the measurements may be performed by any involved network entity, and in case the entity does not include the NTN-PCCE, the measurement report is forwarded to the NTN-PCCE.

In accordance with embodiments, the UE may measure and report one or more of the following on the downlink:
a receive-transmit, Rx-Tx, time difference between a time the UE received a DL reference signal and a time the UE sent out an UL reference signal,
a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values, and
the network side may measure and report one or more of the following on the uplink:
a receive-transmit, Rx-Tx, time difference between a time the NW entity or the further NW entity, like a NTN Gateway or an antenna connector of a TRP, received an UL reference signal and a time the NW entity or the further NW entity sent out a DL reference signal,
a receive time of an UL reference signal or a quality corresponding to the receive time, like a ToA or a phase,
a difference in receive time between first and second reference signals, like a Reference Signal Time Difference, RSTD, between two UL reference signals, UL-RSs,
one or more Doppler values.

In case of a transparent NTN component payload, like in NTN components operating in accordance with the bent-pipe principle, the measurements are done by a network entity on the ground that is connected to the NTN component. The measurement has the combined effects of the service link and the feeder link, and the impact of the feeder link is compensated, for example by removing the influence of the feeder link from the measurements associated with the uplink and/or downlink, e.g., by subtracting from the uplink/downlink measurement a respective measurement on the feeder link, like subtracting a feeder link delay from a total delay estimated or measured for the uplink and/or the downlink.

In case of a regenerative NTN component payload, the uplink and/or downlink measurement is done directly at the satellite, i.e., only transmissions over the service link are involved so that no compensation is needed.

The Doppler values may be used in addition to or instead of the measured timing or signal strength values associated with the uplink and/or downlink. Doppler measurements may be carried out and reported, more specifically, a Doppler shift in the carrier frequency used by the satellite may be measured and based on the Doppler shift measurements a pseudo range may be obtained and, thereby, a distance between the measuring point and the satellite. Using the Doppler values for determining the pseudo range is a well-known approach in the field of satellite technologies and is not described in more detail here.

The above-mentioned DL reference signal may be any one of the following:
a Synchronization Signal Block, SSB,
a downlink Positioning Reference Signals, DL-PRS, transmitted by the NTN component,
a Channel-State Information Reference Signal, CSI-RS,
any Pseudo Noise, PN, sequence or one or more orthogonal sequences, like a Gold code, and
   the UL reference signal may be any one of the following:
a Physical Random Access Channel, PRACH, preamble,
a Sounding Reference Signal, SRS, or a SRS for positioning,
a Demodulation Reference Signal, DMRS,
a Phase Tracking Reference Signal, PTRS,
any Pseudo Noise, PN, sequence or one or more orthogonal sequences, like Zadoff Chu Sequences.

In accordance with embodiments, UE 306 may report a difference between the GNSS time and the UE time and/or the timing advance. Further, the measurements by UE 306 and the network entity may include an indication of the quality of the measurements and/or the RSRP of the received signals that were measured.

For verifying the location, e.g., for the PLMN/AMF selection, the NTN-PCCE determines the UE position on the basis of the measurements in the GNSS, and the measurements associated with the uplink and/or downlink for obtaining the NW generated UE position. As described above, dependent on certain criteria, the position may be considered to be reliable or not. The NTN-PCCE verifies the UE reported UE location, i.e. the UE position generated by UE 306 itself and reported to the NTN-PCCE using the NW generated UE position. If the NTN-PCCE determines the UE reported UE position to be reliable, on the basis of the NW generated position, it sends an initial UE message and registration request 230 to the AMF belonging to the PLMN selected by UE 306 (see FIG. 3.) Otherwise, the NTN-PCCE rejects the registration and, optionally, informs the UE that the UE may not register with the PLMN, based on the location provided by the UE. The network may also specify how long UE 306 needs to wait before trying again and may also optionally indicate the accuracy requirement with which UE needs to report the UE position.

In case the purpose of verifying the location is to provide a location report to other clients, the NTN-PCCE may provide the location report received from the UE to the client in case the location report includes or indicates a UE reported UE position that has been verified. The client may be another NGA-RAN node, the UE or any Location Services, LCS, client.

The verification of a UE reported UE location at the LMF is similar to the above-described process except that the LMF in the core network processes the measurements, and the measurements may be reported to the LMF by the UE using the LPP interface and by the NR-RAN node gNB1 using the NRPPa interface. The LLP request location information procedure may be used to request the measurements from the UE, and the NRPPA measurement request procedure may be used to request the measurements from the NG-RAN node. In case the UE is measuring signals from satellites connected to different gateways, the gNBs associated with these gateways may exchange the measurements and/or configuration via the XN interface.

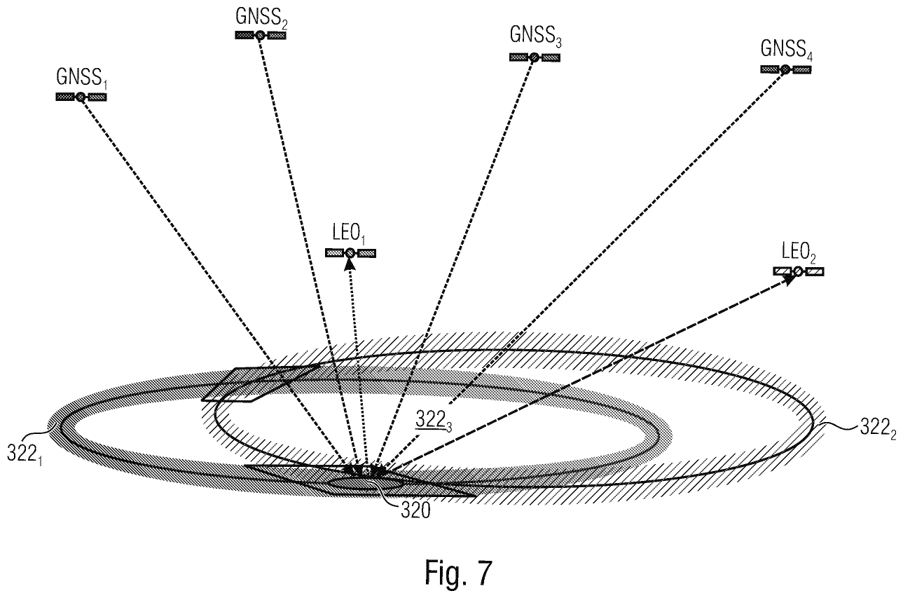

FIG. 7 illustrates an embodiment of a UE position verification using the measurements of a plurality of satellites of the NTN, like two NTN satellites LEO₁ and LEO₂, and the measurements of a plurality of GNSS satellites. FIG. 7 illustrates four GNSS satellites GNSS₁ to GNSS₄ on the basis of which the UE determines its location 320 on its own. On the basis of the measurements over the NTN satellites LEO₁ and LEO₂ the network determines the possible locations 322₁ and 322₂ of the UE, e.g., from a timing advance (TA) measurement or a round trip time, RTT, measurement. The network side determines the area covered by both LEO₁ and LEO₂, namely area 322₃, as the area within which the UE position is assumed, and since the UE-calculated position 320 is within the area 322₃, in the scenario of FIG. 7, the UE reported UE position is verified.

In accordance with embodiments, the NTN measurements may involve only a single NTN satellite. The UE 306 may obtain range measurements and/or angle measurements and/or Doppler measurements to only one NTN satellite. The assistance data for performing the measurements on downlink reference signals may be provided to the UE using a broadcast, multicast or unicast transfer mechanism. The UE may determine a time of arrival, ToA, to at least one GNS satellite and apply corrections, e.g. by Real-Time Kinematics, RTK, Network-Real-Time Kinematics,N-RTK, Precise Point Positioning, PPP, Precise Point Positioning-Real-Time Kinematics, PPP-RTK, Space State Representation, SSR, as may be indicated by the assistance data. The information to acquire GNSS signals and to apply corrections may be provided in a SIB or may be signaled to the UE by the network. The UE provides the UE measurements for the GNSS and the measurements over the NTN satellite. The UE may transmit uplink reference signals if configured to do so by the network to allow the network side to measure the uplink. The network, like the NTN-PCCE or the LMF, may determine the position of the UE using the measurements from the NTN node and/or the GNSS signals and, optionally, may verify a reported UE position as well using the determined or NW generated UE position.

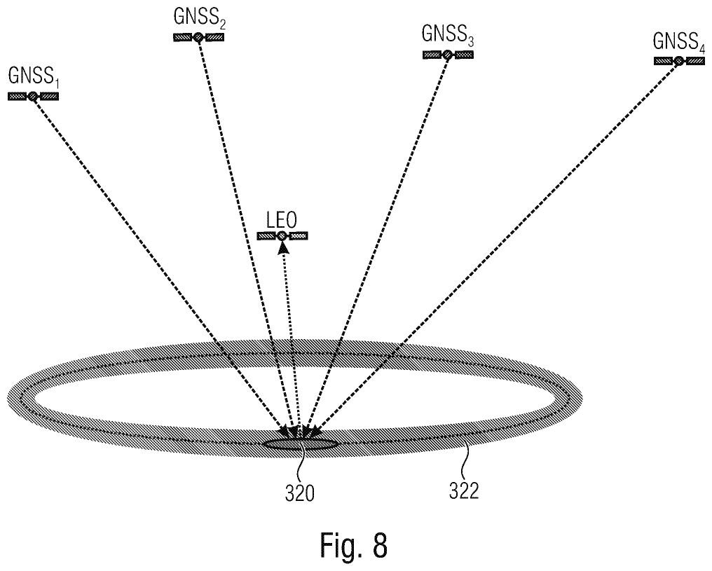

FIG. 8 illustrates an embodiment of a UE position verification using the measurements of a single satellite LEO of the NTN, and the measurements of a plurality of GNSS satellites. FIG. 8 illustrates four GNSS satellites GNSS₁ to GNSS₄ on the basis of which the UE determines its location 320 on its own. On the basis of the measurements over the NTN satellite LEO the network determines the possible location 322 of the UE from a TA measurement or from a RRT measurement with reference to the single LEO satellite. In FIG. 8, it may be seen that the UE-calculated location 320 is verified to be within an area 322 identified by the TA/RTT measurements.

Thus, FIG. 7 depicts the verification of the UE position based on a measurement to only one satellite, and FIG. 8 depicts the verification of the UE position based on a measurement of ranges from the UE to two satellites. In other words, it is verified whether the position reported by the UE is consistent with an expected measurement for this position. When the network makes a single measurement from a single satellite, it has several plausible locations where the UE may be. The more independent measurement (e.g. different physical quantities, e.g. using different satellites) the network may make, the more the network may reduce the number of plausible locations and verify the UE location with more certainty. The measurement may be a one-way range (for example: ToF, ToA) made by the network side or it may be two-way ranging (for example: RTT). In case of RTT, both the network node and the UE report the differences between the transmit and receive time and the RTT is obtained by adding them up. The range is half of the round-trip time. In FIG. 7 and in FIG. 8, an omnidirectional antenna at a satellite is shown for easy explanation. Given an omnidirectional antenna, the UE is within an intersection between a cone and a plane given range to a single satellite (FIG. 7) where the range between the UE and satellite is maintained. In this case, the NW may only verify the position of the UE within the intersection of the conic section with the plane containing the UE. With additional information, such as an angle to the UE that may be independently determined at the network (for example, using the antenna pattern and/or estimation of angle using Doppler shift), the location may be determined more precisely. In case of two satellites (e.g. FIG. 8), the intersection points of the possible location of UE already reduces to two such regions. Using further information, the position may be verified within a certain threshold to the UE reported position.

### Determining/Verifying the UE Position Using Measurements in the NTN

In accordance with further embodiments, a UE position of a UE located in a NTN is determined/verified using only measurements associated with the uplink and/or downlink.

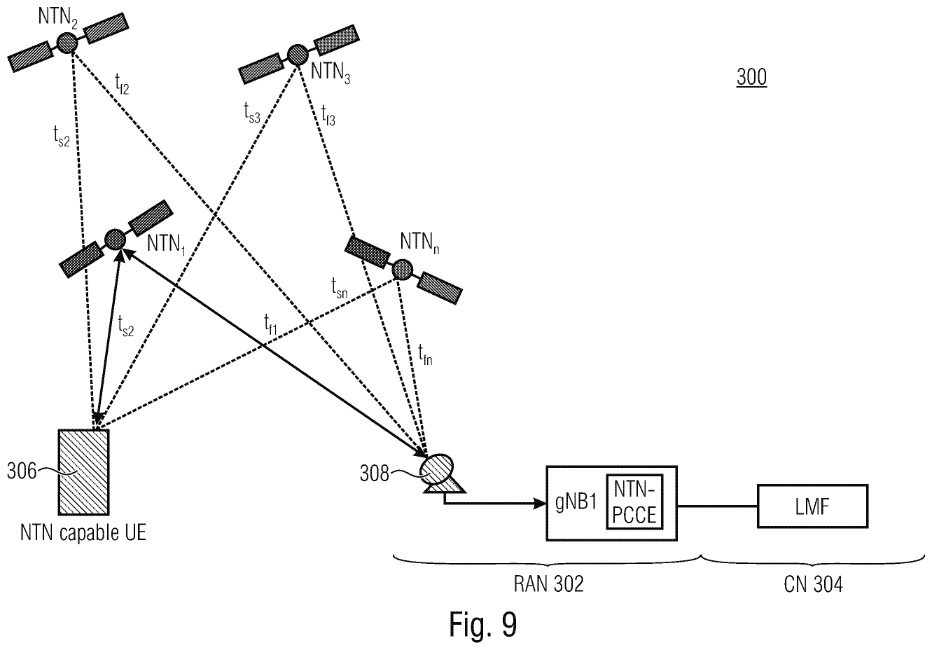

FIG. 9 illustrates a NTN in accordance with embodiments determining/verifying the UE position using measurements in the NTN. The NTN 300 comprises the RAN 302 and the CN 304 and a plurality of NTN components in the form of four NTN satellites NTN₁ to NTN₄. The RAN 302 comprises the RAN node gNB1 including the NTN-PCCE, and the NTN gateway 308 connecting to the respective NTN satellites. Further, FIG. 9 illustrates the NTN capable UE 306 connecting to the RAN 302 via the NTN satellites. The NTN-capable UE 306 determines the reception time in UE time DL reference signals from the RAN and the transmission time in UE time of UL reference signals to the RAN. UE 306 reports the UE RX-TX time difference measurements to the network. The UE may indicate the downlink resources and uplink resource it used for reporting the UE RX-TX time difference measurement. For the same resources, gNB1 may compute the RX-TX time difference at a network side. The measurement point on the network side may be an antenna connector or a phase center or an antenna reference point of the NTN gateway 308 for transparent satellites, or it may be an antenna connector or antenna reference point of the satellites in case of regenerative satellites. The just-mentioned measurements, in the embodiment of FIG. 9, are associated with the downlink from the RAN 302 to UE 306 and with the uplink from the UE 306 to the RAN 302.

For the other satellites, in accordance with embodiments, UE 306 may also compute the RSTD with respect to the serving satellite for the resources used to report the RX-TX time difference and the gNB1 may compute the RSTD with respect to the serving satellite before the uplink resource the UE transmitted. The relative time difference between the resources used for RSTD measurements transmitted and/or received by the neighboring satellites and the resource used by the serving cell may be determined and used for calibration of the range estimates. In accordance with further embodiments, the contribution of feeder link to the range or range difference may be compensated for the transparent satellite payload, as described above. In accordance with other embodiments, the network may compute the position using at least one range measurement, like an RRT measurement to the serving NTN satellite NTN₁ and/or at least one range or a range difference measurement to neighboring NTN satellites and/or at least one terrestrial component, like a base station, a TRP or a reference device and/or to at least one sidelink measurement, like a reference device or another UE coupled to UE 306 via the sidelink.

On the basis of the measurements from the UE and the measurements from the gNB, the NTN-PCCE or the LMF may determine the UE position, i.e. determine the NW generated UE position and/or verify a UE reported UE location against the NW generated UE position.

### Determining/Verifying the UE Positioning Using a Combination of NTN Components and One or More Terrestrial TRPs

In accordance with embodiments, the UE position may be determined/verified at the network side of a NTN on the basis of the measurements associated with the uplink and/or downlink, as described in the preceding embodiment, and in addition on the basis of information of range measurements to a terrestrial TRP.

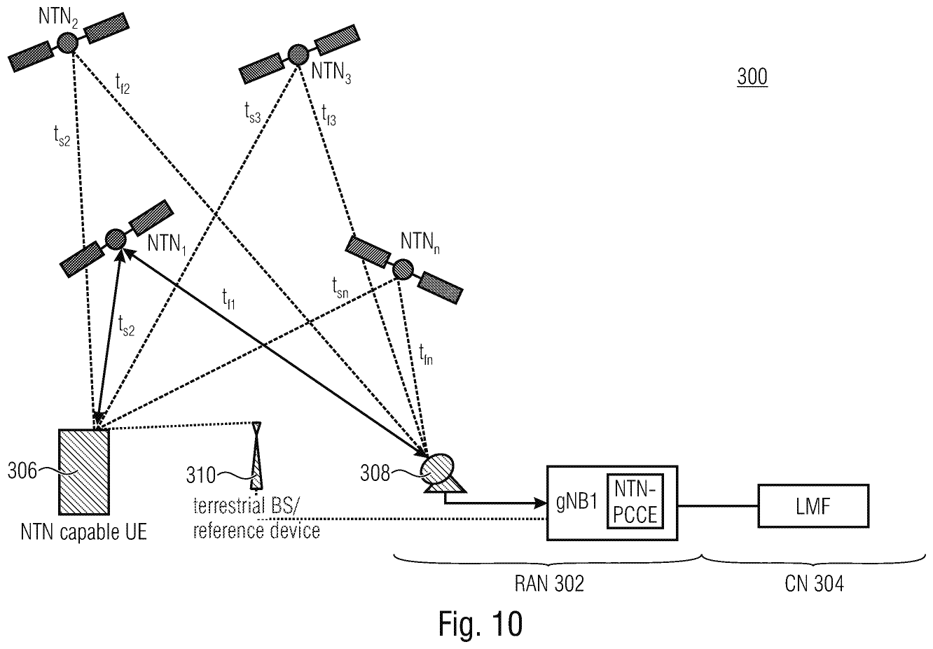

FIG. 10 illustrates an embodiment for the determination/verification of a position of a NTN-capable UE 306 by combining at least one measurement to one terrestrial TRP 310, like TRPs in accordance with the NR or LTE standard, for example a further gNB or base station, and at least one measurement from the NTN. The network 300, initially, may determine the range measurements and/or angle measurements and/or Doppler measurements to the TRP 310. For performing such measurements, UE 306 may be provided by the network with assistance data as a multicast, broadcast or unicast message. Further, UE 306 may receive assistance data or a SIB indicating measurements performed by UE 306 with regard to one or more of the NTN satellites NTN₁-NTNₙ. This may also include the above mentioned corrections to be applied to the respective measurements. For example, responsive to receiving the assistance data/SIB, the UE may determine a ToA to at least one NTN satellite and apply the corrections. The information may be similar to DL-PRS assistance data provided for DL-TDOA, multi-RTT, DL-AOD for terrestrial networks. The correction data may contain information concerning the time offset between the satellites, a delay on the feeder path and the like. UE 306 reports to the network the UE measurements to the one or more NTN satellites and to the one or more TRPs, thereby allowing the network to determine the position based on information provided by the NG-RAN node and/or the UE. The position may be determined or verified using the measurements from the NTN nodes and from the TRP.

In case UE 306 is measuring signals from satellites connected to different gateways, the gNBs associated with the respective gateways may exchange the measurement and/or configuration via the XN interface. The UE and the NG-RAN node may provide the location measurements also to the LMF.

### Determining/Verifying the UE Position Using the Sidelink

In accordance with embodiments, the network like the NG-RAN or the LMF, may provide UE 306 with assistance data to compute a range to a reference device and/or a range difference to at least two network entities, one of which may be the reference device. The UE may provide the range between the UE and at least one reference device or arrange differences between the UE and two reference devices.

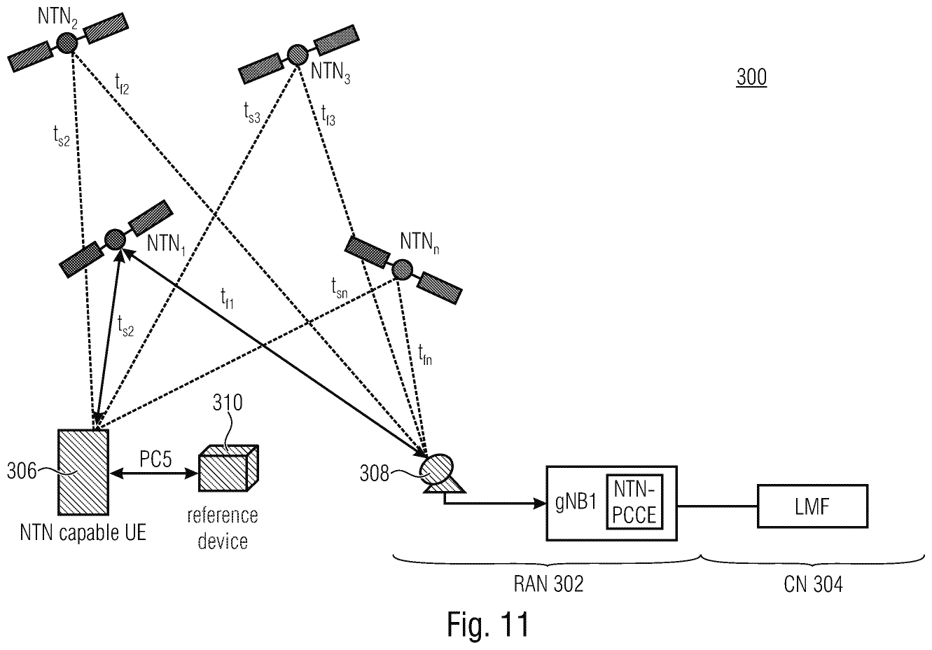

FIG. 11 illustrates an embodiment of a NTN 300 including the RAN 302 and the CN 304 as well as the NTN components in the form of the NTN satellites NTN₁-NTNₙ. Further, a reference device 310 is provided that is capable to couple to the NTN-capable UE 306 via the sidelink, using, for example, the PC5 interface. The UE may provide the computed range or range difference or receive-transmit time difference to the position computing entity, like the NTN-PCCE or the LMF. A UE that initiates a registration with the NTN network may make further sidelink measurements on the sidelink between UE 306 and the reference device 310 to support the NG-RAN node that is connected to the NTN gateway 308. In accordance with embodiments, a UE trying to register to the network may determine a range to the reference device 310 and include the range to the reference device in a message for registering the UE with the PLMN.

In accordance with embodiments, UE 306 may have a sidelink capability, in addition to the NTN capability. This may be announced to other UEs in the vicinity of UE 306. UE 306 may transmit assistance data to the UEs in the vicinity, for example a Timing Advance, TA, value the receiving UE may use for a given satellite, a satellite orientation with respect to the reference device and/or a position of the relative transmit power values, the virtual cell-ID of the location where the reference device is found, an identifier for the NTN UE assisting the first UE for helping to select a virtual cell.

According to an embodiment, if a NTN-capable UE is not equipped with a positioning system, like GNSS, it may take assistance information from the NTN-capable UEs using sidelink or from the reference devices for determining the settings for initiating the RACH and/or for sending positioning reference signals in the uplink.

The position verification may take place at the LMF or at the NG-RAN.

For example, the reference device 310 may broadcast an identifier explicitly over the sidelink or the identifier may be derived based on the configuration of a sidelink reference signal or based on system time. The network may provide a configuration to the reference device how to derive its temporary ID and an authentication codeword to transmit to UEs in its vicinity. UE 306 which is in the vicinity of the reference device 310 receives the temporary ID and the authentication codeword and, optionally, a system time at the time of reception. The system time may be the network time of the GNSS, in case the UE is equipped with GNSS. In accordance with embodiments, UE 306 receiving the reference device identifier and the authentication codeword over the sidelink attaches the received identifier and the received authentication codeword to the message to the network. If the network validates that the authentication codeword provided by UE 306 attempting to register to the network matches with the authentication codeword generated by the reference device 310 at the appropriate time, the network determines that the reference device and UE 306 attempting to register are in vicinity with each other and verifies the location, e.g., verifies the location of the UE 306 to be the location of the reference device 310.

In accordance with other embodiments, the reference device 310 is expected to receive an identifier and an authentication code word from the NTN-capable UE 306 as well and returns this to the network. This two-way handshake allows the network to determine that UE 306 detects the reference device 310 and that the reference device 310 detects UE 306.

The reference device 310 may be a terrestrial TRP, like a base station, a roadside unit or any transceiver configured to transmit and/or receive radio signals. The device 310 may also be a further UE connected to the NTN's RAN.

In accordance with embodiments, UE 306 may perform a sidelink ranging to determine a range and/or angle from the reference device 310. The reference device 310 may be a Very Small Aperture Satellite Terminal, VSAT, or a further UE already connected to the network and that may have GNSS capabilities. The identifier of the further UE 310 may be provided to UE 306 which reports to the network its location and the identifier of the further UE 310. The identifier of the further UE 310 may be the identifier that the NG-RAN or the CN used to identify the further UE 310, such as a RNTI, a 5G-S-TMSI and the like. It may also be another identifier which the network associates with the further UE 310 for the purpose of a relative location determination. In accordance with other embodiments, the identifier may be a virtual cell-ID used by the reference device 310 and UE 306 may select to use the virtual cell-ID of a reference device 310 based on certain criteria while sending the message to register UE 310 with the network, like the RRCSetupComplete message.

### Determining a Suitable PLMN/AMF Based on a UE Reported Identifier

In accordance with further embodiments, the UE may compute a UE location based on the GNSS system or based on another terrestrial wireless system. The NTN provides assistance data for the UE to acquire GNSS signals and to perform corrections. The network may transmit a location of one of more reference points and assistance data indicating a region around the reference point. The UE uses the position determined by the UE itself, for example on the basis of the GNSS, to select one of the signaled reference points and use the identifier or location of this reference point to be the UE location.

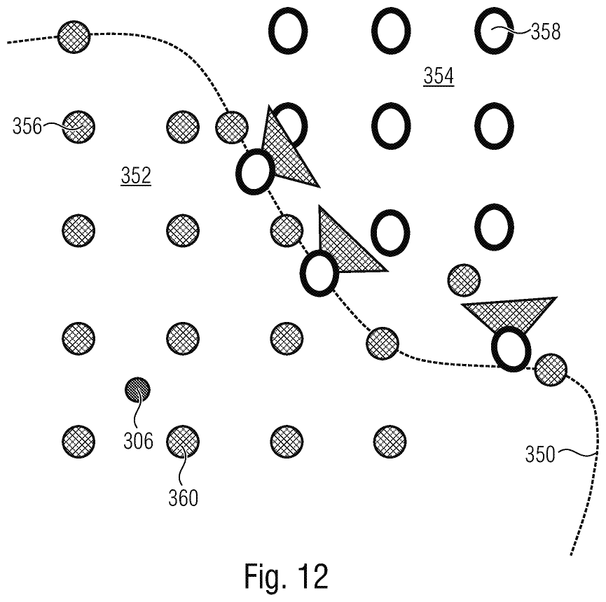

FIG. 12 illustrates an embodiment allowing a NTN-capable UE to identify its position with reference to a certain reference point signaled by the NTN. FIG. 12 illustrates an area, like a geographical area, divided at a border 350 into, e.g., two countries. It is assumed that the NTN allows access of UEs only in case they are within the countries' borders for, example within area 352 but does not allow access of a UE when located in area 354. In FIG. 12, the reference points 356 are indicated that are provided or transmitted by the network together with information specifying the location while no location information for reference point 358 in area 354 are provided. For example, the reference points that specify a location and a direction may signal the UE that a certain PLMN may be selected or a certain NCGI is in certain angular direction from the reference points (e.g. between 0 and 180 degrees with respect to the geographical north) or in a certain cardinal direction (e.g. North of the reference point). The position determined by the UE may be compared to the position of the reference point and its direction with respect to the reference point may be determined. If the UE lies in the specified direction of the reference point within a certain specified direction, then the UE may either choose the identifier of this reference point to report as the UE location.

Thus, the network indicates for the reference points 356 the location thereof and UE 306 may determine, based on its own UE generated location, for example from the GNSS, to which of the reference points it is closest and may signal the reference point or the location information as the actual UE position. In FIG. 12, UE 306 determines to be closest top reference point 360 because the UE determined position and the position of reference point 360 match or are within a predefined range from each other.

For example, the core networks of different PLMNs may provide the criteria for allowing a UE to register in the network. This criteria may include the location and reference location. If the location computed by the UE or by the network is within a certain distance threshold of the reference locations, the UE is allowed to register in the network.

The network may signal to the NG-RAN node whether it allows the UE selected reference location as UE location or whether it needs the NW computed/NW-verified location for admitting the UE. This may be signaled on the NGAP interface or may be O&M.

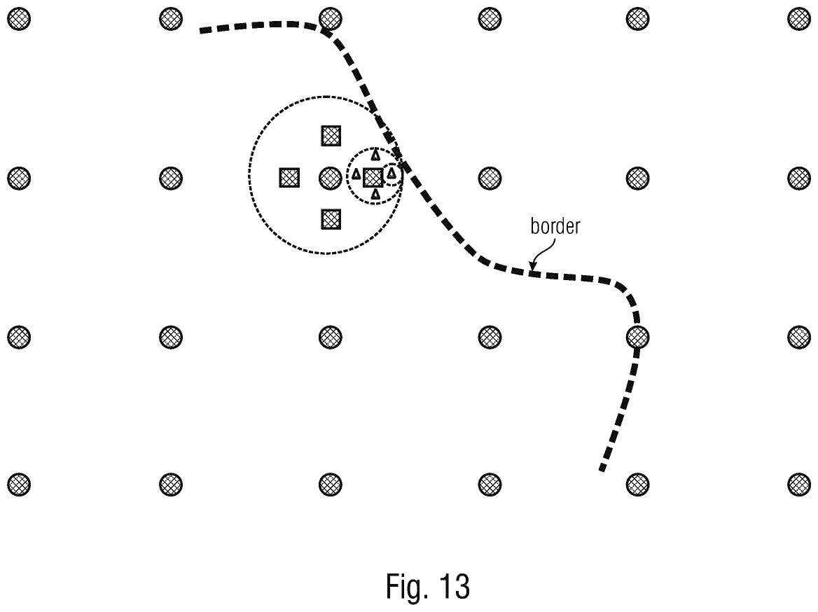

In accordance with embodiments, the reference points may be associated with a location of virtual cells, and the NTN cell may provide the UE with the coordinates of such reference points as a part of the broadcast/multicast/unicast transmission of system information. The NTN may additionally provide a mapping of the location of the virtual cells to the NR-CGI of a NTN cell. The UE 306 may include one of the identifiers obtained from the virtual cells into the RRCSetupComplete message and in the dedicated NAS message. In accordance with embodiments, as is illustrated in FIG. 13, virtual cells signaled to the UE 306 in the NTN 300 may have a larger radius towards the middle of the country and the radius may become smaller toward the border. Towards the border the virtual cells may be arranged in a hierarchical order and the UE may traverse the hierarchy to select the cell that closely follows the border.

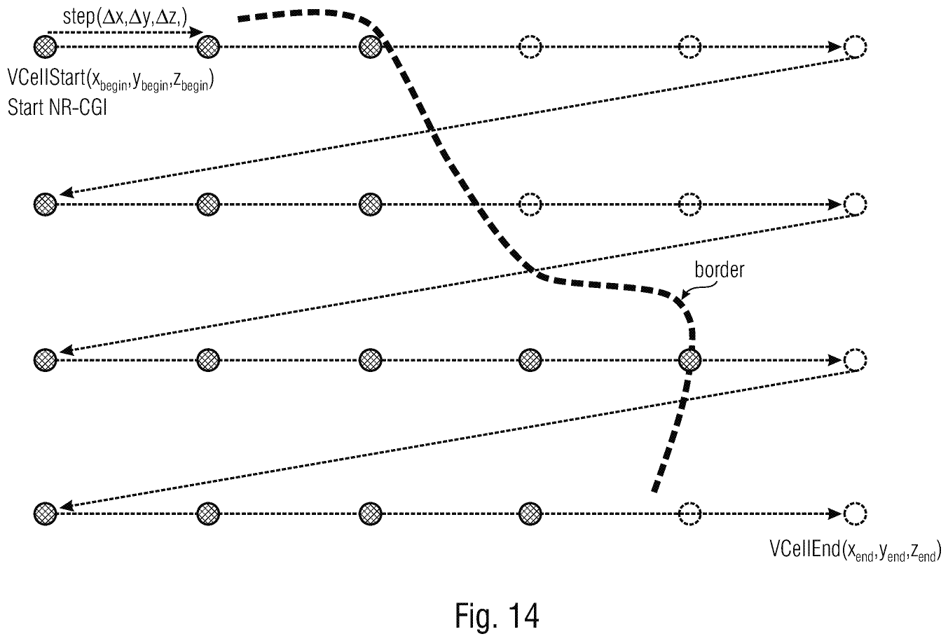

FIG. 14 illustrates an embodiment in accordance with which virtual cells are specified at two corners of a plane containing the virtual cells and the separation between the virtual cells across length and width and the mapping of the NR-CGI to the virtual cells. The virtual cells outside the border may optionally be signaled to the UE with the PLMN where they belong to or they may be marked invalid.

During the registration with the network (e.g. before receiving the RegistrationAccept message by the UE), the UE may be provided with assistance data regarding the location of the reference points (e.g. virtual cells), and their mapping to the PLMN. This assists the UE to prepare the dedicated NAS message addressing the PLMN that the UE intends to register with. To enable the network to check whether the UE is allowed to register with this PLMN at this location, the UE may either provide its location as it computed using one of the UE based methods, provide an altered version of position, or signal the nearest reference point. When the UE reports an altered version of position, it adds an offset and a rotation. The offset and/or rotation may depend at least one of the following: a UE identifier that may not be known to NG-RAN node before security activation (e.g. Subscription Concealed Identifier, SUCI, or Subscription Permanent Identifier, SUPI, or portions thereof), time (e.g. system frame number). This information may be such that the NG-RAN may be able to retrieve the true position from the corrupted position by undoing the transformation done by the UE after AS security is enabled. The CN may be able to provide reverse transformation parameters to the NG-RAN node (offset, rotation) to retrieve the real position or the NG-RAN may be able to compute the parameters based on the user identifier provided by the network. The UE position may be quantized, and least significant bits may be dropped to limit the accuracy of the reported information in order to conceal the accurate position of the UE while providing the information to the network. There may be scenarios, where the UE may have a privacy profile where the user has denied consensus to transmit its fine position. In such scenario, the NW may override the privacy settings of the UE and mandate the UE to report the UE position by truncating the LSBs. The number of bits that may be truncated by the UE may optionally be signaled by the network.

In embodiments where the reference points are provided, there are two variants.

In the first variant, the reference points are spaced on a wider grid as a first level of hierarchy. Towards the edge of a border delineating PLMN (e.g. country border), there are hierarchies of reference points within the region of wider cells until the cell of lowest hierarchy is found. The UE uses the information from the cell of lowest hierarchy to select the PLMN and/or inform this identifier to the NG-RAN network.

In the second variant, the coverage region is described by one or more rectangular planes. One such rectangular plane is depicted in FIG. 14. Here the coordinates of the diagonally opposite points of the grid are provided. Furthermore, the start identifier and end identifier of a reference point is provided. Furthermore, the separations between the points (in x direction and y-direction) are provided. These information enable to determine which reference points are available. Each of such reference points may be mapped to one or more PLMN. Alternatively, if a particular plane is only associated with a certain plane, the points that fall outside the coverage of the PLMN may be signaled to the UE. The UE may only select the PLMN if its location corresponds to one of the reference points provided to the UE.

The information may be provided in one of the SI messages for the UE. Alternatively, a list of points may be provided to the UE to choose from.

### Verifying the UE Location Based on a Virtual Cell and RTT Between UE and Satellite

In accordance with further embodiments, the network may provide assistance data to the UE to perform measurements on a certain transmitted downlink signal. The network may provide further configuration data to the UE to transmit uplink reference signals. The UE determines the time instant when the UE receives the downlink reference signal, the UE time, and the time instant when the UE transmits the uplink reference time, the UE time. The UE reports the difference between the time the UE transmitted the uplink signal and the time the UE received the downlink signal. The UE may also report the transmit time and/or receive time.

The network takes the transmit time of the DL-RS reported by the UE and the reception time of the UL-RS sent by the UE to obtain the roundtrip time, RTT. The range may be used by the network to determine whether an expected range from a satellite to the location reported by the UE or the expected range from the satellite to the location of the virtual cell selected by the UE are within an acceptable threshold.

Optionally, the UE may report Doppler values, angle measurements and the network may determine an angle of arrival or angle of departure based on the DL-RS reported by the UE and verify the UE location.

For example, the UE reported Doppler values and/or Doppler values measured at the network side (compensating for the impact of feeder link and/or precompensations (if any) where needed) may be compared against the expected Doppler values determined by the network for this UE position and the satellite position, given the parameters of the orbital motion of the satellite.

Use of Time Variant Measurements from a Single Satellite or from Multiple Satellites for Determining/Verifying the UE Position

In accordance with embodiments, in a wireless communication network including as NTN components one or more satellites, like satellites of a GNSS, time variant measurements from a single satellite or from multiple satellites may be used for determining/verifying a UE position.

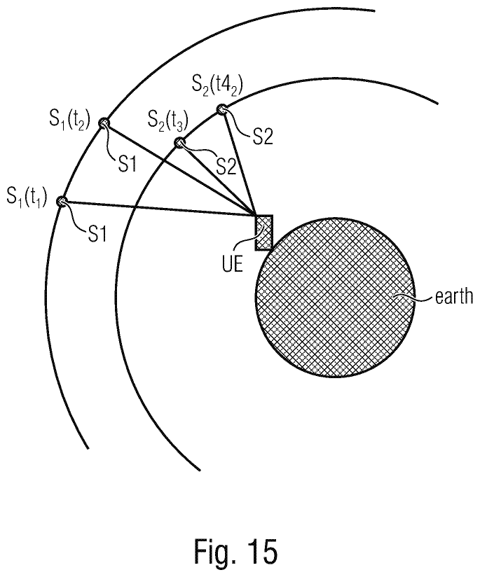

FIG. 15 illustrates an embodiment using time variant measurements from one or two satellites S1, S2 for a verification of the UE position. S1(t1) is the position of satellite S1 at time instant t1, and S1(12) is the position of the same satellite S1 at time instant t2 with t2 being not equal to t1. Optionally, there may be a second satellite S2, whose position is S2(t3) at time instant t3 and S2(t4) at time instant t4, with t3 being not equal to t4.

For verifying or computing the UE position, the NW entity may take into account the measured values or changes in measured values depending on the satellite position and use this to verify the UE position. For example, the time variant measurement may include one or more of the following: a change in the measured range from the UE to the satellite, a change in a measured Doppler shift, a change in a measured angle from the satellite to the UE. Likewise, if there is more than one satellite, the measurements made by the satellites at different points in may be used for determining/verifying the UE position.

### Determining/Verifying the UE Location Using Artificial Intelligence (AI)

In the embodiments described so far, the determination and/or verification is performed in a certain NW entity, e.g., by a processor or the like operating in accordance with a predefined and fixed algorithm allowing the UE position to be determined/verified using the information provided. In other words, the determination and/or verification of the NW generated UE position is performed by a certain NW entity which solves, as described above, a linear system or respective equations utilizing, e.g., the geometric relationship between UE and the NW-entity and/or GNSS. For computing the position of a UE in closed form or iterative solution, the NW entity uses as an input one or some or all of the obtained information. If the ToAs (or equivalently TDOAs) between the UE and four known points in space are known, then the position and time error may be solved by forming a system of linear equation. Well known algorithms like the Chan-Ho algorithm, the Levenberg-Marquardt, Bancroft algorithms may be used to solve the equations. Likewise, geometric methods utilizing the range and the angle between transmitter and receiver may be used to estimate the position of the user in closed form. For example, if the measurement of range and AoD between the transmitter and receiver is available, then the position may be computed by determining the point which is at a certain angle and a certain range by solving geometric relations.

However, the present invention is not limited to such approaches. Rather, in accordance with further embodiments, the UE position may be determined/verified using artificial intelligence (AI) approaches, for example by using machine learning, operating on the basis of one or more of the above mentioned information.

When considering the determination and/or verification of a UE position, the use of AI is particularly advantageous because in scenarios where a closed form solution may either not be determined by solving classical positioning methods or is error prone, the AI-ML model may be trained to learn from the data and find a suitable model that may map the observables to a UE position. Such scenarios may, for example, occur when insufficient NTN satellites are visible or where the satellites are visible only from a certain field of view or where the synchronization may not be assumed to run classical ToA or TDOA based solutions. The AI/ML model may also take the UE reported position together with other information and determine whether the UE reported position may be ascertained to be within a certain error margin or not.

The AI supported determination and/or verification of a UE position may comprise one or more machine learning models and/or a deep learning models to be used. The particular model chosen by the network may be subject to capabilities of network elements and/or UE-capabilities. To have a common understanding of the used model between one or more network nodes, the parameters used for classification may need to be communicated between the entities. This is especially important when the model is trained at a different network entity compared to the network entity where the model is deployed, An example of the entity where the AI/ML model is trained may be the LMF or the network data analytics function (NWDAF). An example of where the AI/ML model is deployed may could be the UE or the NG-RAN node or the NTN Gateway or the LMF. It may also be possible that the network entity may be training one or more models to predict the location dependent parameters (e.g. PLMN applicable to the area).

In the following, the concept of verification and/or generation of a location of the UE or parameters pertaining to the location of the UE is described using a convolutional neural network (CNN) approach as an example. However, any other model for AI/ML or deep learning may be equally used for this purpose. As an example: the AI/ML model may be any of the following approaches:
CNN,
recurrent neural networks (RNN),
long short term memory (LSTM),
any supervised machine learning method,
any unsupervised machine learning method,
any combination of supervised and non-supervised learning methods,
decision trees,
random forest,
K-neighbour methods,
channel charting. or
simply any model that maps the measurement and/or information to a location and/or a system parameter derived based on location.

A key, however, is that the entities providing the trained model to a second entity, needs to provide parameters to completely deploy the method. These parameters may be a description of the topology of nodes and weights underlying the model, the input output parameter, activation functions and so on depending on the model used.

A network entity may indicate a second network entity or a UE about the model it has used, for example, a network node 1 (the node training the network) may tell a network node 2 (the node using the network), how the model looks like and how to use the weights by specifying one or more of the following parameters:
1) The topology of network, e.g., an artificial neural network (ANN) or a convolutional neural network (CNN).
2) The number of hidden layers.
3) The number of nodes in each hidden layer.
5) The number of output nodes.
6) Parameters defining the nature of a connection between two nodes, e.g. feedback nodes (e.g. in case of LSTM), weights, activation functions (for example, in a convolutional neural network), etc.
7) The measurements and/or information taken as input, also referred to as an input set or feature set.

For example one, some or all information for determining a NW generated UE position of a UE may be used as input into the ANN or CNN, e.g., one or more measurements from the UE, one or more measurements from one or more further NW entities of the wireless communication network, the one or more further NW entities performing the one or more measurements, one or more measurements made by the NW entity, coordinates of a reference point in the wireless communication network that is less than a predefined distance from the UE, a reference device in the wireless communication network that is within a hearability range of the UE.

In accordance with embodiments, the input parameters used by the network entity and/or the UE may include one or more one of the following:
a time of arrival, ToA, measurement,
a receive-transmit, Rx-Tx, time difference measurement,
a carrier phase measurement,
a Doppler shift measurement,
an angle of arrival, AoA, measurement,
an angle of departure, AoD, measurement,
a Reference Signal Time Difference, RSTD, measurement,
a Reference Signal Received Power, RSRP, measurement,
a Round Trip Time, RTT, measurement,
a location of the moving TRP (e.g. satellite, drone, etc.),
a location of the fixed or a moving gateway (e.g. fixed ground station, moving ground station, a second NTN component, etc.),
a known or estimated UE location,
a reliability of UE estimate,
a NR-CGI of terrestrial cells,
a UE identity of Sidelink UEs assisting with NTN access.

### 7) The Output Parameter or Parameters Estimated by the Model, e.g., One or More System Parameters, a Location.

In accordance with embodiments, the output parameters may include one or more of the following:
a two-dimensional, 2D, UE location,
a three-dimensional, 2D, UE location,
parameters of UE location (e.g. country or PLMN ID),
parameters of transmission from the UE (e.g. timing advance),
parameters of transmission and/or reception from the UE (e.g. beam direction),

### 8) The Weights Connecting at Least Two Nodes of the ANN or the CNN.

The weights are determined at the NW node training the model. When the network node is provided with data (e.g. measurements) and/or other information (e.g. NR-CGI of neighboring terrestrial cells), the network node is expected to predict a parameter (e.g. a selected PLMN). In case of a training data set, a testing data set and a cross-validation data set, the parameter to be predicted is known with a certainty (or at least with a certain degree of confidence). Therefore, the network node may be provided with the measurement and the information needed (as input) as well as the information it is expected to output. The combination of the input information (features) and the expected output is a training instance in a training data set. The network node determines the parameter with the weights it has so far, and determines (i.e. predicts) the output. At the beginning, the model may simply be random numbers or some initial model available at the network (for example through O&M or initial configuration or a model obtained from previous trainings, e.g. before significant change in the environment). If the predicted output does not match the expected output (available for a training data set), then the weights of the paths connecting the output node with the node of previous layers are adjusted to come to the weight that would have predicted the output correctly. There is a well-known backpropagation technique used in ML, which is used for computing weights connecting different nodes. When the model predicts the output correctly for the data in the test data set (as opposed to a training data set or a cross-verification dataset), the model may be deployed for predicting the network parameters using the same data used for training this model, either at the same network node or at a different network node.

In case of a network verification, a simple example is now given. The input may be the following:
measurements (e.g. Doppler shift, ToA, TDOA, etc.) from one or more NTN data communication satellites in LEO/MEO/GEO range and measurements from one or more GNSS ranges
TA to the serving satellite
Location of GNSS satellites
Location of NTN satellites

The expected output may be
selectedPLMN

Then the network entities may collect the above information from several UEs where the above information is considered accurate. For example, the selectedPLMN selected by UEs in general may be considered reliable, if the use case is to determine those UEs that are trying to fake the selected PLMN position. Using the model available at the network node training the model, the NW node may determine whether the model predicted the selectedPLMN correctly. If not, then the backpropagation technique tries to adjust the weights of the paths connecting two nodes so that the new model predicts this data correctly.

When the model is trained and achieves desired performance on data sets in a test set, i.e. on data which has not been used for training the model, then the model may be deployed.

In a related case, where the UE position needs to be determined, the training data may consist of the same data as above, and the output data is the UE position. If the UE position is not correctly predicted, the backpropagation procedure adjusts the weight every time a new training data is used. When the performance on the test data set is within the needed error margin, the model may be used for determining the UE position either at the same node or at a second node.

In case of verification, the last node may already output a verified status, i.e., the position reported by the UE corresponds to the true position of the UE (within a certain margin). For example, the parameter selectedPLMN depends on the UE location, and the model determines whether the UE has used the correct PLMN based on the measurements made.

In accordance with embodiments, the one or more models include channel charting, simultaneous location and mapping (SLAM), etc. In case of channel charting, the reported measurements by the UE are grouped together in terms of similarity in the measurements, but the real locations for these UEs are not known. This shows the UEs, which are nearby, are grouped together but it is not yet known where they are or how far apart in physical dimensions they are. The information obtained using UEs whose location is known may be fused together to provide a scaling and a reference point for determining the location of the rest of the points. Hence, for UE positioning, the measurements from the UEs whose location are unknown and those whose location are known may be classified to see which UEs are similar (i.e. closer) in a measurement space. Then the UEs whose location is known provide information to obtain the scaling and reference points to be able to estimate the unknown locations of the UEs.

According to embodiments, the network entity and/or UE trains the one or more models using measurements and additional information. Additional information may be, for example, one or more of the following:
TA used to the serving cell
NR-CGI of Neighboring terrestrial cells detected
Identifiers obtained from other UEs in a sidelink
Information obtained by the UE as assistance data from the terrestrial network
Locations of NTN satellites
Location of GNSS satellites

These are the training data. If the expected input/output is known a supervised learning approach is applied. If the expected input/output data is not known a similarity learning approach is applied. If the expected input/output data is known for part of dataset, it may be used for other techniques such as channel charting.

A network entity may train one or more ML models, wherein each ML may correspond to a different set of features used. The ML models used may be indicated by an identifier, which allows a unique understanding of the ML model used between two entities. Each ML model may result in different accuracy and/or reliability values. A second network entity and/or a UE may signal the first network entity and/or the UE to report position or network parameters corresponding to an indicated model.

Stationary UEs or UEs with higher reliability of position estimates may be used to train a ML model for verifying and/or generating estimates. An indication of a stationary UE or an indication of confidence in the position of the UE may be used as a feature in training the ML model.

According to embodiments, more than one AI model may be available, and the NW entity, e.g., a UE may select one or more AI models to be employed. For example, the network entity and/or UE utilizes machine learning (ML) and/or a deep learning model, which takes at least one measurement and/or at least one additional information (see above) in order to determine a suitable model for determining and/or verifying a UE location and/or determining parameters of the system (e.g. PLMN, country, area, TA, etc.).

In accordance with embodiments, when more than one AI models is selected, like n AI models with n=2,3, . . . , the NW entity may perform n-step process for the UE positon determination/verification such that the output of one model may be refined by a subsequent model. In other words, the process may start with a coarse determination/verification followed by one or more finer determinations/verifications using the other models. A model may be trained to obtain coarse position information using fewer information. Then based on the coarse location (e.g. a country is detected), a more sophisticated model may be used to predict a finer position (which may use more measurements and more information). The output of the coarse processing may be a trigger for selecting another model for a finer positioning determination. For example, if a position has determined by coarse location to be in Nuremberg, then a trained model for Nuremberg may be used to determine a fine position. In other words, the network entity may determine or verify a UE position successively using one or more ML models. In line with this embodiment, one of the models may give a coarse location. After determining a coarse location, a second ML model possibly with a different set of features may provide a more accurate and/or a more reliable location for the UE.

In accordance with embodiments, the one or more models are provided as configuration parameter by one network entity to another network entity. As an example, the NG-RAN node may be provided with such a configuration via NRPPa or NGAP protocol. In other embodiments, the model may also be exchanged between network entities using the operation and maintenance (O&M) interface, or using network signaling, or via databases. In a yet other embodiments, the model may be provided to the UE by a network entity (e.g. the LMF or the serving gNB). Likewise, a UE may also train the one or more models and provide the one or models to another UE or a network entity. Furthermore, a UE may provide the one or more models received from a network entity to a third UE.

The network entity training the one or more model may use one of the ML models (e.g. supervised learning), wherein the network entity is provided with the input including at least one measurement and/or at least one additional information and an output including the information that needs to be determined using the input. Using the above set of input, the model predicts the “expected output”. If it does not (which is normal during training), the model weights are adjusted so that for this data, a correct output is predicted.

After training the model with a large training dataset, the expected output would be the same as predicted output with a test data set. In accordance with embodiments where the position of the UE is to be determined at the network, the measurements made by UE and/or network entities and/or further information (such as satellite position at measurement) may be provided as input and the known or computed location of the UE may be provided as an expected output. After training the machine learning model, the parameters defining the ML model (weights, topology, . . . etc.) is exchanged to another network entity and/or the UE.

According to embodiments, the network may separate the data collected from different UEs into training sets, cross-verification sets and test sets. The network informs another network entity and/or a UE the values of cross-validation error and/or test error. This information indicates whether the network entity is generating position estimates with a needed accuracy and/or reliability. According to embodiments, a network entity or a UE may select one ML model over another ML model based on at least cross-validation error and/or at least the test error.

In accordance with an embodiment, a procedure for generating the UE position or for verifying the UE position may comprise the following steps:
1) The network entity and/or the UE has trained the ML model itself or receives the configuration of the ML model.
2) The network entity and/or the UE uses the input parameters (e.g. the measurements, information, etc.) the model is trained with.
3) Using the ML model, an estimate of the parameter (e.g. UE location, PLMN, country . . . etc.) is obtained.

The ML model used by the network entity to determine the position of the UE or the ML model provided by the network to the UE may be subject to UE capabilities.

Furthermore, the ML model used by a network entity during different states (e.g. RRC state) or state transitions may be different. For example, during the initial access the ML model may use fewer features to generate a coarse position. Such position may be used to verify whether the UE is allowed to initiate a signaling connection towards a particular PLMN or not. Likewise, during an emergency call, the location may be determined more precisely and more features and/or measurements may need to be performed (at the network side) and/or requested to be measured and/or reported by the UE.

### General

Although the respective aspects and embodiments of the inventive approach have been described separately, it is noted that each of the aspects/embodiments may be implemented independent from the other, or some or all of the aspects/embodiments may be combined.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a RAN network entity, like the gNB, comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

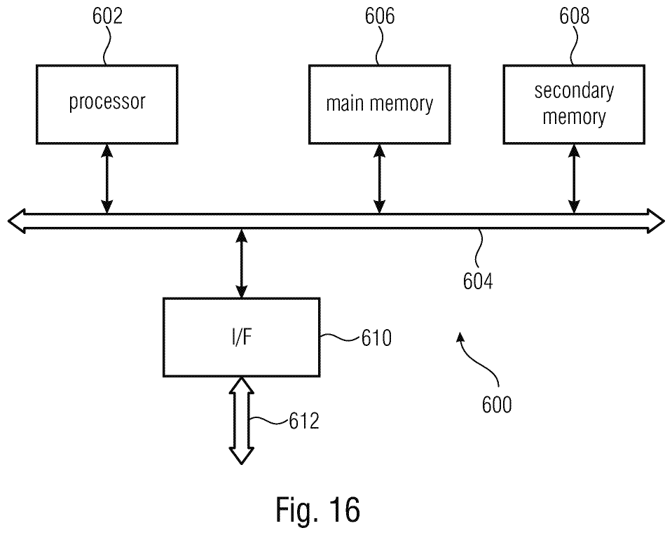

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A network, NW, entity for a wireless communication network, the wireless communication network including one or more non-terrestrial network, NTN, components,
wherein the NW entity is to
obtain information for determining a network, NW, generated UE position of a user device, UE,
determine, using as an input some of the obtained information, the NW generated UE position by solving equations,
receive from the UE a UE position, the UE position indicated by a geographical location of the UE or by information derived from a UE location and from assistance data obtained from the wireless communication network, and
verify the received UE position using the NW generated UE position,
wherein the NW entity is to verify the received UE position to be correct or acceptable in case the UE position is within a geographical area identified by the NW generated UE position, and
wherein the NTN component is an airborne vehicle or a spaceborne vehicle.

2. (canceled)

3. The network, NW, entity of claim 1, wherein the information for determining the NW generated UE position of the UE comprises one or more of the following:
one or more measurements from the UE, e.g., a receive-transmit, Rx-Tx, time difference between a time the UE received a DL reference signal and a time the UE sent out an UL reference signal,
one or more measurements from one or more further NW entities of the wireless communication network, the one or more further NW entities performing the one or more measurements,
one or more measurements made by the NW entity, e.g., a receive-transmit, Rx-Tx, time difference between a time the NW entity received an UL reference signal and a time the NW entity sent out a DL reference signal.

4. The network, NW, entity claim 3, wherein the one or more measurements comprise one or more of the following:
one or more measurements of one or more ranges between the UE and at least one satellite of a Global Navigation Satellite System, GNSS, used by the UE to determine the UE position,
one or more measurements of a range, like ToF, or a range difference, like TDOA, between one or more reference devices, like a terrestrial transmission and reception point, TRP,
a combination one or more measurements of a range, like ToF, and/or a range difference, like TDOA, using one or more signals transmitted and/or received by at least a first system and at least a second system,
one or more measurements of a range, like time of flight, ToF, between the UE and a first entity in the RAN and one or more measurements of a range difference, like TDOA, between the UE and at least a second entity in the RAN,
one or more time variant measurements from the satellite, e.g., one or more of the following: a change in the measured range from the UE to the satellite, a change in a measured Doppler shift, a change in a measured angle from the satellite to the UE.

5. The network, NW, entity of claim 4,
wherein the first system and the second system comprises:
a GNSS,
one or more TRPs of one or more terrestrial networks,
one or more integrated access and backhaul nodes, IABs,
one or more access network entities of one or more non-terrestrial networks, like one or more NTN satellites,
one or more terrestrial beacon systems,
one or more reference devices in the wireless communication network, and
wherein the first entity in the RAN and the second entity in the RAN comprises:
one or more TRPs of one or more terrestrial networks,
one or more integrated access and backhaul nodes, IABs,
one or more access network entities of one or more non-terrestrial networks, like one or more NTN satellites,
one or more terrestrial beacon systems,
one or more reference devices in the wireless communication network.

6. (canceled)

7. (canceled)

8. The network, NW, entity of any one of the preceding claims, wherein the UE position is determined using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

9. (canceled)

10. The network, NW, entity of any one of the preceding claim, wherein the NW entity is to receive from the UE a location report including
the geographical location of the UE, e.g., a latitude, a longitude, an altitude, or
the information derived from the UE location and from the assistance data obtained from the wireless communication network, e.g., a location of one or more virtual points and an association of the one or more virtual points with one or more of the following:
a Public Land Mobile Network, PLMN,
a list of PLMNs,
a tracking area identity, ID,
a list of tracking area IDs,
a virtual New Radio, NR, Cell Global Identifier, NCGI, identifier,
an identifier associated with an access point in the wireless communication network,
an identifier associated with a reference device,
an identifier associated with a transmit and reception point, TRP.

11. The network, NW, entity of claim 10, wherein, when obtaining the information for determining the NW generated UE position, the NW entity is to receive from the UE
a message including the UE position and the information, or
a first message including the UE position and a second message including the information.

12. (canceled)

13. (canceled)

14. The network, NW, entity of any one of the preceding claims, wherein the at least one measurement further comprises one or more of the following:
a time of arrival, ToA, measurement,
a receive-transmit, Rx-Tx, time difference measurement,
a carrier phase measurement,
a Doppler shift measurement,
an angle of arrival, AoA, measurement,
an angle of departure, AoD, measurement,
a Reference Signal Time Difference, RSTD, measurement,
a Reference Signal Received Power, RSRP, measurement,
a Round Trip Time, RTT, measurement.

15. (canceled)

16. The network, NW, entity of any one of the preceding claims, wherein the NW entity is to indicate a reliability of the NW generated UE position or the verified UE position, e.g., a reliability level or a verification level associated with the UE position, e.g. with each reliability level or verification level mapping to a certain combination of accuracy in vertical direction and/or horizontal direction and/or statistical variation and/or the verification method used.

17. (canceled)

18. (canceled)

19. (canceled)

20. (canceled)

21. The network, NW, entity of any one of the preceding claims, wherein the NW entity is to send or is to cause another NW entity to send to the UE assistance data and/or a measurement request, the assistance data and/or the measurement request indicating to the UE one or more of the following:
signals to be measured by the UE, e.g., downlink reference signals, like Demodulation Reference Signals, DMRSs, Positioning Reference Signals, PRSs, or sidelink reference signals, or Global Navigation Satellite System, GNSS, signals, or signals of a terrestrial beacon system,
one or more configurations for transmitting one or more reference signals,
one or more configurations for reporting the one or more measurements.

22. The network, NW, entity of any one of the preceding claims, wherein the NW entity is to receive from another NW entity, like a LMF or an Operation and Maintenance, O&M, mechanism, or from an operator of the NTN components, assistance data, the assistance data supporting the NW entity to determine and/or verify the NW generated UE position.

23. (canceled)

24. (canceled)

25. (canceled)

26. The network, NW, entity of claim 21 or 22, wherein the NW entity is to send or is to cause another NW entity to send to the UE assistance data supporting the UE to receive GNSS signals.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. A user device, UE, for a wireless communication network, the wireless communication network including one or more non-terrestrial network, NTN, components and a network, NW, entity determining a NW generated UE position by solving equations,
wherein, for allowing the NW entity to verify a UE position using the NW generated UE position, the UE is to transmit to the NW entity the UE position, the UE position indicated by a geographical location of the UE or by information derived from a UE location and from assistance data obtained from the wireless communication network,
wherein the UE position is to provide indicated by one or more of the following information:
information derived from a UE location and from assistance data obtained from the wireless communication network
a geographical location of the UE, e.g., a position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS
wherein the NW entity is to verify the received UE position to be correct or acceptable in case the UE position is within a geographical area identified by the NW generated UE position, and
wherein the NTN component is an airborne vehicle or a spaceborne vehicle.

64. (canceled)

65. (canceled)

66. (canceled)

67. The user device, UE, of claim 63, wherein the information for determining the NW generated UE position of the UE comprises one or more of the following:
a report of one or more measurements by the UE,
a report of coordinates of a reference point in the wireless communication network that is less than a predefined distance from the UE or coordinates of the UE location as computed by the UE.
one or more UL reference signals.

68. The user device, UE, of claim 67, wherein the one or more measurements comprise one or more of the following:
one or more measurements of one or more ranges between the UE and at least one component of the separate positioning system used by the UE to determine its position,
one or more measurements of a range, like time of flight, ToF, or a range difference, like time difference of arrival, TDOA, between the one or more NTN components,
one or more measurements of a range, like ToF, or a range difference, like TDOA, between one or more reference devices, like a terrestrial transmission and reception point, TRP,
one or more measurements of a range, like time of flight, ToF, between the UE and a first entity in the RAN and one or more measurements of a range difference, like TDOA, between the UE and at least a second entity in the RAN,
a receive-transmit, Rx-Tx, time difference between a time the UE received a DL reference signal and a time the UE sent out an UL reference signal,
a receive time of a DL reference signal or a quality corresponding to the receive time, like a ToA or a phase,
a difference in receive time between first and second reference signals, like a Reference Signal Time Difference, RSTD, between two DL reference signals, DL-RSs,
one or more Doppler values.

69. (canceled)

70. The user device, UE, of any one of the claims 63 to 68, wherein the UE is to receive assistance data and/or a measurement request, the assistance data and/or the measurement request indicating to the UE one or more of the following:
signals to be measured by the UE, e.g., downlink reference signals, like Demodulation Reference Signals, DMRSs, Positioning Reference Signals, PRSs, or sidelink reference signals, or Global Navigation Satellite System, GNSS, signals, or signals of a terrestrial beacon system,
one or more configurations for transmitting one or more reference signals,
one or more configurations for reporting the one or more measurements.

71. (canceled)

72. (canceled)

73. (canceled)

74. (canceled)

75. (canceled)

76. A method for operating a network, NW, entity for a wireless communication network, the wireless communication network including one or more non-terrestrial network, NTN, components, the method comprising:
obtaining information for determining a network, NW, generated UE position of a user device, UE, and
determining using as an input one or some or all of the obtained information the NW generated UE position by solving equations,
receiving from the UE a UE position, the UE position indicated by a geographical location of the UE or by information derived from a UE location and from assistance data obtained from the wireless communication network, and
verifying the received UE position using the NW generated UE position,
wherein the NW entity is to verify the received UE position to be correct or acceptable in case the UE position is within a geographical area identified by the NW generated UE position, and
wherein the NTN component is an airborne vehicle or a spaceborne vehicle.

77. A method for operating a user device, UE, for a wireless communication network, the wireless communication network including one or more non-terrestrial network, NTN, components, the method comprising:
providing, by the UE, one or more of the following information:
information for determining and/or verifying a network, NW, generated UE position of the UE at a network, NW, entity of the wireless communication network, and/or
a UE position determined by the UE using a separate positioning system, the separate positioning system including one or more of the following: a non-terrestrial system, like an assisted global navigation satellite system, A-GNSS, e.g., GPS, Galileo, Glonass, Beidou, and/or a terrestrial system, like a sensor system, a Wireless Local Access Network, WLAN, system, a Bluetooth system or a Terrestrial Beacon System, TBS.

78. A non-transitory computer program product comprising a computer readable medium storing instructions which, when executed on a computer, perform the method of claim 76 or 77.

79. (canceled)
